(19) United States
(12) Patent Application Publication
(10) Pub. No.: US 2007/0238605 A1
(43) Pub. Date: Oct. 11, 2007

(54) Catalysts for the Simultaneous Removal of Carbon Monoxide and Hydrocarbons from Oxygen-Rich Exhaust Gases and Processes for the Manufacture Thereof

(76) Inventors: Wolfgang Strehlau, Dossenheim (DE); Olga Gerlach, Ludwigshafen (DE); Jurgen Maier, Mannheim (DE); Tamara Gabriel, Bruchsal (DE)

Correspondence Address: Stephen D. Scanlon;Jones Day, North Point, 901 Lakeside Avenue, Cleveland, OH, 44114, US

(21) Appl. No.: 11/578,185

(22) PCT Filed: Apr. 25, 2005
(86) PCT No.: PCT/EP05/04421

§ 371 Date: Nov. 22, 2006

(30) Foreign Application Priority Data
Apr. 26, 2004 (DE) 10 2004 020 259.1
Oct. 7, 2004 (DE) 10 2004 048 974.2

(51) Int. Cl. B01D 53/94; B01J 29/18; B01J 29/08; B01J 29/04; B01J 29/06; B01J 23/44; B01J 21/00; B01J 29/00

(52) U.S. Cl. 502/60; 502/339; 423/213.5; 502/64; 502/66; 502/74; 502/77; 502/78; 502/79

(57) ABSTRACT

Catalyst containing tin oxide, palladium and a carrier oxide, characterized in that tin oxide and palladium are present on the carrier oxide in a roentgenographically amorphous or a nanoparticular form or that the carrier oxide is present in a nanoparticular form or that both tin oxide and palladium and the carrier oxide are present in nanoparticular form. Said catalyst has the function of the simultaneous removal of carbon monoxide and hydrocarbons from oxygen-rich exhaust gases.

The present invention relates to catalysts for the simultaneous removal of carbon monoxide and hydrocarbons from oxygen-rich exhaust gases, for example from Diesel engines, lean Otto engines and stationary sources. The catalysts contain a carrier oxide, which is loaded with palladium and tin oxide. In one embodiment, tin oxide and palladium are present on the carrier oxide in a roentgenographically amorphous or nanoparticular form. In another embodiment, the carrier oxide is present in nanoparticular form. Preferably, the carrier oxide contains silicon or aluminum. Optionally, the catalyst can contain other metals of the platinum group as well as oxides of indium, gallium, alkali metals, earth alkali metals and the rare earth elements as promoters. The catalysts have a high conversion performance for carbon monoxide and hydrocarbons, a highly thermal stability and a good sulfur resistance. The invention also relates to a process for the manufacture of the catalysts as well as to a process for the purification of exhaust gases by using the new catalysts.

The important harmful substances from the exhaust gas of Diesel engines are carbon monoxide (CO), unburned hydrocarbons (HC) like paraffins, olefins, aldehydes, aromatic compounds as well as nitric oxides (NOₓ), sulfur dioxide (SO₂) and particles of carbon black, which contain carbon both in solid form and in form of the so-called “volatile organic fraction” (VOF). Further, Diesel exhaust gas contains also oxygen in a concentration, which is, dependent on the working point, around 1.5 and 15%.

The harmful substances, which are emitted from lean Otto engines, for example from Otto engines, which injects directly, consists substantially of CO, HC, NOₓ, and SO₂. Compared to CO and HC, the oxygen is present in a stoichiometrical surplus.

In the following, Diesel engines and lean Otto engines are termed as “lean combustion engines”.

Industrial exhaust gases as well as exhaust gases from domestic fuel also can contain unburned hydrocarbons and carbon monoxide.

The term “oxygen-rich exhaust gas” encompasses an exhaust gas, in which oxygen is present in a stoichiometrical surplus compared to the oxidizeable harmful substances like CO and HC.

Oxidation catalysts are employed for the removal of harmful substances from said exhaust gases. Said catalysts have the function of removing carbon monoxide as well as hydrocarbons by oxidation, wherein in the ideal case water and carbon dioxide are generated. Additionally, also carbon black can be removed by oxidation, wherein also water and carbon dioxide are formed.

U.S. Pat. No. 5,911,961 discloses an oxidation catalyst made from a metallically or ceramically monolithic body with a catalytically active coating of two components. As first component, Pt and/or Pd and at least one of the oxides of W, Sb, Mo, Ni, V, Mn, Fe, Bi, Co, Zn and earth alkali are employed on a first fire-resistant (refractory) oxide, for example TiO₂ or ZrO₂, wherein the second component consists of a second refractory oxide, for example Al₂O₃, SiO₂, TiO₂, ZrO₂, SiO₂—Al₂O₃, Al₂O₃—ZrO₂, Al₂O₃—TiO₂, SiO₂—ZrO₂, TiO₂—ZrO₂, zeolites.

EP 1 129 764 A1 discloses an oxidation catalyst, which contains at least one zeolite and additionally one of the carrier oxides aluminum oxide, silicon oxide, titanium oxide and aluminum silicate and one of the noble metals Pt, Pd, Rh, Ir, Au and Ag.

U.S. Pat. No. 6,274,107 B1 discloses an oxidation catalyst, which contains cerium oxide, optionally aluminum oxide and a zeolite, for example β-zeolite. Furthermore, the zeolite can also be doped with the metals of the platinum group. The described catalyst promotes the oxidation of CO, HC and of the hydrocarbons which are condensed on the carbon black particles.

EP 0 432 534 B2 discloses a continuously working oxidation catalyst with high conversion performance for hydrocarbons and carbon monoxide in low temperature ranges. The catalyst consists of vanadium compounds and metals of the platinum group, which are applied on finely divided aluminum oxide, titanium oxide, silicon oxide, zeolite as well as the mixtures thereof. According to the Tables 2 and 3 of said document, the values for the 50% conversion of CO and HC (T₅₀ values, which are also termed as light-off temperature) for the freshly prepared catalysts are above a temperature of 200° C.

EP 0 566 878 A1 discloses an oxidation catalyst with high conversion performance for hydrocarbons and carbon monoxide and inhibited oxidation properties towards nitric oxide and sulfur oxide. The catalyst contains a monolithic body, which consists of an activity-promoting dispersion coating made from finely divided metal oxides like aluminum oxide, titanium oxide, silicon oxide, zeolite, or the mixtures thereof, as carrier and a catalytically active component. As active components, the metals of the platinum group are employed, which are doped with vanadium or an oxidic vanadium compound. According to Table 1 of said document, the light-off temperatures (T₅₀) in the light-off tests at Diesel engines are between 195° C. and 220° C. for the CO oxidation for the freshly prepared catalysts and between 210° C. and 222° C. for the HC oxidation.

WO 03/024589 A1 claims a catalyst for the purification of Diesel exhaust gases, which is characterized in that at least one noble metal is deposited on a non-porous silicon dioxide, which for example can be gained by means of flame hydrolysis form silicon tetrachloride. The catalysts which are produced according to said process exhibit a very good sulfur tolerance.

Catalysts are also known, which use tin oxide as catalytically active component.

U.S. Pat. No. 6,132,694 discloses a catalyst for the oxidation of volatile hydrocarbons, which consists of a noble metal like Pt, Pd, Au, Ag and Rh, and a metal oxide, which has more than one stable oxidation states, and at least tin oxide. The metal oxide can be doped with small amounts of oxides of the transition metals. Other oxides are not mentioned. The catalyst is produced in a manner that preferably a monolithic body is loaded with several layers of tin oxide. Then, the noble metal is applied onto the tin oxide. According to the examples, in particular good results are obtained when the noble metal is platinum and the oxide with more than one stable oxidation state is tin oxide.

U.S. Pat. No. 4,117,082 discloses oxidation catalysts, where tin oxide is used as carrier for the active components Pt, Pd, Rh, Ir and Ru. Also other carrier oxides like Al₂O₃ or SiO₂ and magnesia can be used. The catalysts are produced in a manner that firstly the active component is precipitated onto the tin oxide. Then, in a second step, the obtained solid particles are precipitated from an aqueous suspension onto the carrier oxide. So, a catalyst is obtained which consists of a carrier oxide which is coated with tin oxide, where the tin oxide is coated with the active components.

U.S. Pat. No. 4,855,274, U.S. Pat. No. 4,912,082 and U.S. Pat. No. 4,991,181 disclose catalysts for the oxidation of carbon monoxide to carbon dioxide. Said catalysts consist of silica gel, which is coated with tin oxide. Then, in a second reaction step, a metal of the platinum group, preferably platinum, is applied onto the tin oxide layer in form of an aqueous solution. So, a catalyst is obtained, which consists of a carrier oxide, which is coated with tin oxide, which in turn is coated with platinum or a platinum-containing compound.

As a rule, the technically employed catalysts contain platinum as active component. In the following, the advantages and drawbacks of such catalysts are discussed briefly.

Besides the oxidation of CO and HC, the formation of NO₂ from NO and oxygen is also promoted. Dependent on the total functionality of the oxidation catalyst, this can be an advantage or a drawback.

In connection with carbon black filters, the formation of NO₂ at the Diesel oxidation catalyst may be desired, because the NO₂ contributes to the degradation of carbon black, i.e. contributes to the oxidation thereof to carbon dioxide and water. Such a combination of Diesel oxidation catalyst and filter for carbon black particles is also termed as CRT-system (continuously regenerating trap) and, for example, is disclosed in the patents EP 835 684 and U.S. Pat. No. 6,516,611.

Without the use of filters for carbon black in the exhaust gas line, the formation of NO₂ is undesired because emitted NO₂ results in a strong unpleasant odor.

Because of the chemical and physical properties of platinum, the platinum-containing catalysts have considerable drawbacks after highly thermal stress.

The exhaust gas temperatures of effective Diesel engines, which frequently are provided with turbo chargers, predominantly are run in a temperature range between 100 and 350° C., wherein regulations are given for the operation points of motor vehicles by the NED-cycles (new European driving cycle). During the operation under partial load, the exhaust gas temperatures are in the range between 120 and 250° C. During the operation under full load, the temperatures reach 650 to 700° C. as a maximum. On one hand, oxidation catalysts with low light-off temperatures (T₅₀ values) are required, and on the other hand a highly thermal stability is required in order to avoid a drastic activation loss during the operation under full load. Furthermore, it has to be noted that unburned hydrocarbons accumulate on the catalyst and can ignite there, so that local catalyst temperatures can be far beyond the temperature of 700° C. Temperature peaks of up to 1000° C. can be achieved. Said temperature peaks can lead to a damage of the oxidation catalysts. Then, in particular, in the low temperature range, no significant conversion of harmful substances is achieved by means of oxidation.

Further, different filters for carbon black for the reduction of the particle emission from the Diesel exhaust gas were developed, which, for example, are described in the patent application WO 02/26379 A1 and in U.S. Pat. No. 6,516,611 B1. During combustion of the carbon black, which accumulates on the particle filters, carbon monoxide can be released, which by means of catalytically active coatings for filters for carbon black can be converted to carbon dioxide. Appropriate coatings can also be termed as oxidation catalysts. For the conversion of the carbon black into harmless CO₂ and water, the collected carbon black can be burned up in intervals, where the necessary temperature for the burn-up of the carbon black can be produced for example by engine-internal methods. The burn-up of the carbon black, however, is associated with a high release of heat, which can lead to a deactivation of the platinum-containing oxidation catalysts, which are applied on the filters.

For the compensation of thermal damages, therefore, platinum-containing oxidation catalysts with high quantities of platinum for exhaust gases from Diesel passenger cars are mostly provided. Said quantities are typically in the range of from 2.1 to 4.6 g/l (60-130 g/ft³). For example, up to 9 g platinum are used for a 2 liter catalyst. The use of high quantities of platinum is an essential expense factor for the treatment of exhaust gases of Diesel vehicles. The reduction of the platinum part in the catalyst is of highly economical interest.

In conjunction with the introduction of Diesel particle filters, apart from the low light-off temperature and the required highly thermal stability further requirements for oxidation catalysts become apparent, which are characterized subsequently.

For example, an oxidation catalyst can be installed upstream of the engine particle filter. Then, it is possible to increase the concentration of hydrocarbons at the oxidation catalyst and to use the heat which is released when burning the hydrocarbons in order to initiate the combustion of the carbon black on the Diesel particle filter, which is installed downstream. Alternatively or also additionally, the Diesel particle filter itself can be coated with the oxidation catalyst. Thereby, the additional coating of the Diesel particle filter has the function to oxidize the carbon monoxide, which is released during the combustion of the carbon black to carbon dioxide. In case of highly thermal stability and simultaneously high activity of such a coating, in some applications, the oxidation catalyst which additionally is installed upstream, could be set aside. Both functionalities of oxidation catalysts, which are here discussed in connection with the Diesel particle filters, require a highly thermal stability of the catalysts wherein platinum-containing catalysts can have drawbacks as mentioned before.

Another problem for the purification of Diesel exhaust gases relates to the presence of sulfur in the Diesel fuel. Sulfur can be deposited onto the carrier oxide and can contribute to a deactivation of the oxidation catalysts by means of catalyst poisoning. Platinum-containing oxidation catalysts show an advantageously good resistance towards sulfur. In the known catalyst formulations, platinum has proved to be superior over the other metals of the platinum group like rhodium, palladium or iridium.

With respect to the treatment of exhaust gases of lean Otto engines, as for example the directly injecting Otto engines, exhaust gas systems are used, which are composed either of a three-way catalytic converter or an oxidation catalyst and a NOₓ-storing catalyst which is installed downstream. In particular, the three-way catalytic converter respectively the oxidation catalyst has the function of minimizing the relatively high hydrocarbon emissions which arise in the homogenously lean operational mode in particular within the inhomogeneously loading state. Thereby, the thermal stability as well as an activity as high as possible at low temperatures of appropriate catalysts, which are mostly used close to the engine, have a superior function.

The object of the invention was to develop a new catalyst for the removal of harmful substances from exhaust gases of lean combustion engines and exhaust air, which can oxidize CO and HC to CO₂ and water with low temperature activity, and which simultaneously performs an improved thermal stability with respect to the catalysts of the prior art as well as a good sulfur resistance. Together with the improvement of the performance properties of the catalyst to be developed a way should be found to decrease the manufacturing costs compared to the previously applied catalysts.

This object could be achieved with a catalyst, which contains tin oxide, palladium and a carrier oxide, which preferably contains silicon and/or aluminum, wherein the catalyst can optionally contain further metals of the platinum group or promoters.

In a first embodiment, the catalyst contains tin oxide, palladium and carrier oxide, characterized in that palladium and tin oxide are present on the carrier oxide in roentgenographically amorphous form or in nanoparticular form.

In a second embodiment, the catalyst contains tin oxide, palladium and a carrier oxide, characterized in that the carrier oxide is present in a nanoparticular form.

The freshly prepared catalysts and the catalysts after aging with sulfur at low temperature exhibit a comparable efficiency for the CO and HC oxidation compared to the catalysts of the prior art. However, they considerably outperform said efficiency after thermal aging at high temperature. Therefore, the catalysts are thermally very stable and simultaneously have a good sulfur resistance.

Furthermore, the catalyst can either be prepared without the expensive noble metal platinum, respectively platinum can be reduced in its quantity in a manner that all in all a reduction of the material costs as well as a reduction of the manufacturing costs is possible compared to the catalysts of the prior art.

When doing without platinum or using only low quantities of platinum, the catalysts according to the invention practically don't tend to the oxidation of NO to NO₂ by means of air oxygen, so that unpleasant odors can be minimized.

When compared to the catalysts of the prior art, the novel catalysts have both technical and economical advantages.

The catalyst of the first embodiment differs from the tin oxide-containing catalysts, which are disclosed in the prior art, that
a) tin oxide and palladium exist in directly topographical proximity together on a carrier oxide particle,
b) tin oxide is present on the carrier oxide in a roentgenographically amorphous or in a nanoparticular form, and
c) palladium is present in a roentgenographically amorphous or in a nanoparticular form,
d) tin oxide and palladium are very homogeneously dispersed on the surface of the carrier oxide.

These differences compared to the catalysts of the prior art are achieved by the processes for the manufacture of the catalyst as disclosed below, by means of the relatively high loading of the carrier oxide with tin oxide or by means of the selection of the weight proportions of the components, which are contained in the catalyst.

The homogeneity of the dispersion of tin and palladium on the carrier oxide can be described thereby that preferably
(1) tin and palladium—when considering the individual particles—are each dispersed in nearly constant concentrations across the particles of the carrier oxide, and
(2) the concentration ratios—when considering the individual particles—of tin to carrier oxide as well as the concentration ratios of tin to palladium on the surface of the particles of the carrier oxide are approximately constant.

Said dispersion includes also that the catalyst, for example, contains mixtures of at least two tin- and palladium-containing carrier oxides, each of them having different tin and/or palladium concentrations. Furthermore, said dispersion also includes that the carrier oxide is manufactured according to the process of the gradient coating. When using a gradient coating, a gradient—for example of the palladium, of the tin, of a promoter or of boron oxide—is adjusted for example across the length of a honeycomb body, which is used for the manufacture of the catalyst, as discussed below.

Preferably, the term “gradient coating” relates to a gradient in the chemical composition.

As a measure method for testing the homogeneity, REM/EDX was used in the context of the present application.

The tin oxide, which is deposited onto the carrier oxide has a roentgenographically amorphous form or a nanoparticular form.

In general, particle sizes can be detected by means of the Scherrer equation from X-ray diffraction analysis:
D=(0,9*λ)/(B cos θ_{B}) Scherrer equation

Herein, “D” means the thickness of a crystallite, “λ” the wave length of the used X-ray, “B” the full width at half maximum of the respective reflex and θ_{B} the position thereof. The fresh catalysts, i.e. the catalysts, which are calcinated at 500° C., have tin oxide particle sizes, which are in the range of from 1 to 100 nm when being are measured according to the Scherrer method, whereas the particle sizes of the tin oxide can depend on the used carrier oxide. In some cases, even no reflexes of the tin oxide are visible, so that the tin oxide which is present on said catalysts, can be termed as being “roentgenographically amorphous”. After aging at 700° C., no or only very little agglomeration of the tin oxide particle is detectable, what depends on the used carrier oxide. This outlines the very good durability of the catalysts according to the invention.

Surprisingly, the roentgenographically amorphous respectively nanoparticular form of the tin oxide is maintained also at a high loading of the carrier oxide with tin.

Palladium is also present in a roentgenographically amorphous or a nonaoparticular form.

In the context of the present invention, the term “nanoparticular” has the meaning that the particle size, which is detected according to the Scherrer equation, is between 0.5 and 100 nm. In particular preferred is a particle size range of the tin oxide between 1 and 50 nm.

The term “roentgenographically amorphous” has the meaning, that by means of X-ray wide angle deflection no analyzable reflexes are obtained which are characteristic for a substance.

The term “tin oxide” which is used in the following includes all possible oxides and suboxides of the tin.

The term “palladium” includes both the element and the possible oxides and sub-oxides.

Preferably, a “carrier oxide” is an oxide, which is thermally stable and which has a large surface. The term “carrier oxide” also includes a mixture of at least two different carrier oxides.

Preferably, such oxides have a BET surface of more than 10 m²/g. In particular preferred are oxides with a BET surface of more than 50 m²/g, more preferred with a BET surface in the range of from 80 to 350 m²/g.

Preferably, carrier oxides are used, which still have a large BET surface after treatment at high temperature. More preferred is also a carrier oxide with a low tendency for the binding of sulfur oxides (SOₓ).

Preferably, the carrier oxide contains silicon and/or aluminum.

A silicon-containing or aluminum-containing carrier oxide is a carrier oxide, which in particular contains silicon oxide, aluminum oxide, silicon/aluminum mixed oxide, aluminum silicate, kaolin, modified kaolin or mixtures thereof.

Furthermore, a silicon dioxide can be applied, which is pyrogenic or which was produced by precipitation of silicon dioxide.

Preferably, also pyrogenic aluminum oxide, α-aluminum oxide, δ-aluminum oxide, theta-aluminum oxide and γ-aluminum oxide can be applied.

Furthermore, aluminum oxides can be used, which are doped with silicon oxide, with oxides of the earth alkali elements or with oxides of the rare earth elements.

As already mentioned before, it basically is possible to apply mixtures of the before-mentioned carrier oxides.

The term “modified kaolins” stands for kaolins, whereas one portion of the Al₂O₃, which is present in the structure, was unhinged by a thermal treatment and a subsequent treatment with acid. The kaolins which were treated in this manner have a larger BET surface and a lower amount of aluminum compared to the starting material. Respectively modified kaolins can also be termed as aluminum silicates and are commercially available.

Additionally to the mentioned oxides, the carrier can also contain mixtures of one or more zeolites.

The admixture of zeolite for the formulation of Diesel oxidation catalysts is already known from the EP 0 800 856. Zeolites have the capability to adsorb hydrocarbons at low exhaust gas temperatures and to desorb said hydrocarbons when the light-off temperature of the catalyst is reached or is exceeded.

As disclosed in the EP 1129 764 A1, the function of the zeolites may be to “crack” long chain hydrocarbons, which are present in the exhaust gas, i.e. to decompose said hydrocarbons into smaller fragments, which then can be oxidized easier by the noble metal.

The zeolites, which are used as admixtures, can be applied in form of H-ZSM-5, dealuminated Y-zeolite, hydrothermally treated Y-zeolite, mordenite or zeolite-β. Said zeolites can either be applied in pure form or as mixtures, where this use also comprises a use of forms of doped zeolites, which are obtained by means of ion exchange or by other treatment.

In particular usable are also hydrothermally stable zeolites with a Si/Al ratio>15. Within the context of the present invention, in particular Y-zeolite, DAY-zeolite (Dealuminated Y), ZSM-5, mordenite and β-zeolite are usable.

Thereby, the zeolite can be present in the sodium form, ammonium form or H form. Furthermore, it is possible to transfer the sodium, ammonium or H form by means of impregnation with metal salts and oxides or by means of ion exchange into another ionic form. As an example, the transfer of Na—Y-zeolite into SE-zeolite (SE=rare earth element) by means of ion exchange in aqueous rare earth element chloride solution is mentioned.

Some examples for carrier oxides which are usable for the invention are the following commercially available oxides, however the present invention is not restricted to:

Siralox 5/320 (Company Sasol), Siralox 10/320 (Company Sasol), Siralox 5/170 (Company Sasol), Puralox SCFa 140 (Company Sasol), Puralox SCFa 140 L3 (Sasol), F (Company Dorfner), F50 (Company Dorfner), F80 (Company Dorfner), F+5/24 (Company Dorfner), F-5/24 (Company Dorfner), F-5/48 (Company Dorfner, F+10/2 (Company Dorfner), F+20/2 (Company Dorfner), SIAL 35 (Company Dorfner), alumina C (Company Degussa), SA 3*77 (Company Norton), SA 5262 (Company Norton), SA 6176 (Company Norton), alumina HiQR10 (Company Alcoa), alumina HiQR30 (Company Norton), Korund (Company Alcoa), MI307 (Company Grace Davison), MI286 (Company Grace Davison), MI386 (Company Grace Davison), MI396 (Company Grace Davison), MI486 (Company Grace Davison), Sident 9 (Company Degussa), Sipernat C 600 (Company Degussa), Sipernat 160 (Company Degussa), Ultrasil 360 (Company Degussa), Ultrasil VN 2 GR (Company Degussa), Ultrasil 7000 GR (Company Degussa), Kieselsäure 22 (Company Degussa), Aerosil 150 (Degussa), Aerosil 300 (Degussa), calcinated hydrotalcit Pural MG70 (Sasol), calcinated hydrotalcit Pural MG50 (Sasol).

Examples for zeolites, which are usable for the invention, however the present invention is not restricted to, are: Mordenit HSZ®-900 (Company Tosoh), Ferrierit HSZ@-700 (Company Tosoh), HSZ@-900 (Tosoh), USY HSZ@-300 (Company Tosoh), DAY Wessalith HY25/5 (Company Degussa), ZSM-5 SiO₂/Al₂O₃ 25-30 (Company Grace Davison), ZSM-5 SiO₂/Al₂O₃ 50-55 (Company Grace Davison), β-zeolite HBEA-25 (Company Süd-Chemie), HBEA-150 (Company Süd-Chemie).

The catalyst is produced by a process which comprises the step (i):
(i) bringing tin and palladium compounds into contact with the carrier oxide.

The term “tin and palladium compounds” stands for all tin and palladium compounds, which can be suspended in a liquid medium and/or are completely or at least partially soluble in said medium.

Preferably, tin and palladium compounds are used, which are completely or at least partially soluble in said liquid medium.

Preferably, the liquid medium is water.

Preferably, tin and palladium salts are applied. For example, salts are the salts of inorganic acids, like halides or nitrates, or salts of organic acids, like formiates, acetates, hexanoates, tartrates or oxalates. The use of complex compounds of tin and palladium is also possible. For example, palladium can be applied in form of soluble ammonium complexes.

Preferably, tin oxalate which is dissolved in water is applied as tin compound, whereas the solubility can be further increased by addition of nitric acid.

If the application of palladium and tin compound is performed simultaneously, then, preferably, the palladium is used in form of its nitrate.

Furthermore, the applied tin and palladium compounds can be subjected to a chemical treatment. For example, said compounds can be treated with acids as described above for tin oxalate. Also the addition of complexing agents is possible. By means of said treatment, for example, said compounds can be transferred into an outstanding good solubility state, which is advantageous for the intended processing.

For the manufacture of the catalysts, a process is preferred, where tin and palladium compounds are applied being chloride-free as possible, because a later release of chloride-containing compounds out from the catalyst can lead to heavy damages of the exhaust gas facilities.

“Bringing into contact” means that the tin and palladium compounds are applied onto the common carrier oxide in suspended or preferably in dissolved form either simultaneously or sequentially.

For the manufacture of the catalyst, all embodiments are preferred, which generally have proved of value within the catalyst research, in particular “washcoat” and/or “honeycomb” and “powder or pellet” technologies. Exemplarily, the embodiments (α), (β), (γ), (δ) are discussed below.

(α) It is possible to proceed in a manner that the predominant portion of the carrier oxide is ground in aqueous suspension to particle sizes of several micrometers and which are then applied onto ceramically or metallically shaped bodies. For this, the shaped body is dunked into the carrier oxide suspension, whereby it is loaded with carrier oxide, i.e. it is impregnated. After thermal treatment like drying or calcination, a shaped body is obtained, which is coated with carrier oxide. Then, the coated shaped body is dunked into the solution of tin and palladium compounds, whereby the carrier oxide is loaded or coated. Then, it is dried and preferably calcinated. The process can be repeated until the desired loading amount is achieved.

(β) However, it is also possible to add the dissolved tin and palladium compounds to the carrier oxide suspension, and then to dunk the shaped body into the suspension, to load i.e. to impregnate, to dry and to calcinate. The process can be repeated as often until the desired loading amount is achieved.

(γ) Furthermore, it is possible firstly to impregnate the carrier oxide with the dissolved tin and palladium compounds, where the used total volume of the impregnation solution respectively the impregnation solutions is below the maximum adsorption capacity of liquid of the carrier oxide. In this manner, an impregnated carrier oxide can be gained, which appears to be dry and which is dried and calcinated in a subsequent step. The composite, which is gained in this manner, can be provided in water and can be ground. Subsequently, the washcoat can be applied onto a shaped body.

(δ) It is also possible, to add the dissolved tin and palladium compounds to the carrier oxide suspension, to filtrate the solid, to dry respectively to calcinate. Alternatively, the suspension, which contains the tin and palladium compounds can be spray-dried and calcinated. Again, for example, the catalyst can be obtained in powder form. Said material can also be used for the coating of shaped bodies, optionally after a grinding-step in aqueous suspension.

Basically, it is not required to apply the tin and palladium compounds simultaneously onto the carrier oxide, i.e. in a common process step. So, for example, at first the tin compound can be processed according to the above processes, whereas the palladium compound for example is applied firstly by impregnation of the shaped body, which is coated with the washcoat in a solution of the appropriate palladium compound.

All known methods can be used for the loading of the carrier oxide by means of bringing into contact with the dissolved tin and palladium compounds as well as for the drying and calcination step of the catalyst. Said methods depend on the selected process types, in particular whether the “washcoat” is applied at first onto a shaped body, or whether a powder process is selected. Said methods comprise processes like “incipient wetness”, “dunking impregnation”, “spray impregnation”, “spray drying”, “spray calcination” and “rotary calcination”. The confection of the catalyst can also be carried out according to the known methods, for example by means of extruding or by extrusion molding.

Therefore, the catalyst according to the invention, is provided preferably as powder, granulate, extrudate, shaped body or as coated honeycomb body.

Apart from the above methods for the homogeneous dispersion of the catalytic active substances onto the carrier oxide, that is the impregnation of the carrier oxide with metal salt solutions, the impregnation of the carrier materials with metal salt solutions, the adsorption of metal salts from liquids and the spraying on of solutions, also the application by means of precipitation from solution or the deposition from solutions can be applied.

The application of tin and palladium compounds from a solution is also possible.

After the loading of the carrier oxide with the tin and palladium compounds, a subsequent drying step and, as a rule, a calcination step is carried out. In case of a spray calcination, as for example described in the EP 0 957 064 B1, drying and calcination can practically be carried out in a single process step.

Therefore, the process also includes the step (ii):
(ii) calcination.

Preferably, the calcination step is carried out at a temperature of from 200 to 1000° C., more preferred of from 300° C. to 900° C., in particular of from 400 to 800° C.

By means of the calcination step, the tin salt is decomposed by means of the temperature treatment and is at least partially transferred into tin oxide.

Also the palladium salt can be converted by means of the temperature treatment into its oxides. Also the formation of elementary palladium is possible.

By means of the calcination step, also the mechanical stability of the catalyst is increased.

Besides the above required components of the catalyst in the catalyst manufacture or for the treatment thereof, auxiliary materials and/or additives can be added to the carrier material, so, for example, oxides and mixed oxides as additives, binders, fillers, hydrocarbon adsorbers or other adsorbing materials, dopants for the increase of the temperature resistance as well as mixtures of at least two of the before mentioned substances.

Said further components can be introduced into the washcoat in water soluble and/or water insoluble form before or after the coating process. After application of all ingredients of the catalyst onto the shaped body, as a rule, the shaped body is dried and calcinated.

Components, with which the catalyst can be doped, for example comprise further materials of the platinum group, i.e. platinum, rhodium, iridium and ruthenium. The term “platinum, rhodium, iridium and ruthenium” thereby comprises both the elements and the oxides.

Therefore, the catalyst is characterized in that it is doped with one or more metals selected from the group platinum, rhodium, iridium or ruthenium.

Therefore, the process for the manufacture of the catalyst also contains the step (iii):
(iii) doping of the catalyst with one or more compounds from the group platinum, rhodium, iridium or ruthenium.

The compounds from step (iii) can already be added in step (i). However, it is also possible adding them at a time where the carrier oxide or the shaped body was already coated, preferably according to one of the preceding methods (α), (β), (γ) and (δ).

Preferably, water soluble salts of said compounds, are applied for example in form of the nitrates thereof. For ruthenium, also ruthenium-nitroso-trinitrate has proved of value. Preferably, the application is carried out by dunking impregnation as described above. After application of all ingredients of the catalyst, subsequently a drying step and calcination step is carried out.

After the calcination step, said metals are present in the catalyst in form of the elements or of the oxides.

By means of doping with the oxides of indium, gallium, the alkali metals, earth alkali metals, the rare earth elements or mixtures thereof, a further activity increase of the catalyst can be achieved. Such compounds are also termed as promoters.

The promoter is dispersed on the surface of the catalyst in a manner that it is homogeneously dispersed together with the tin oxide and the palladium.

The terms “indium oxide”, “gallium oxide”, “alkali metal oxide”, “earth alkali metal oxide” and “rare earth element oxide” include all possible oxides and sub-oxides as well as all possible hydroxides and carbonates.

So the term “alkali metal oxide” comprises all oxides, suboxides, hydroxides and carbonates of the elements Li, Na, K, Rb and Cs.

The term “earth alkali metal oxide” comprises all oxides, suboxides, hydroxides and carbonates of the elements Mg, Ca, Sr and Ba.

The term “rare earth element oxide” comprises all oxides, suboxides, hydroxides and carbonates of the elements La, Ce, Pr, Nd, Pm, Sm, Eu, Gd, Tb, Dy, Ho, Er, Tm, Yb, Lu, Y and Sc.

If the catalyst according to the invention is manufactured by addition of promoters, the tin oxide and the promoters can be present either as mixed oxide or, as the case may be, as oxides with “pyrochloric” structure. “Pyrochloric” oxides can be described with the common empirical formula A₂B₂O₇. In dependence from the quantities of tin- and promoter-containing components which are used for the manufacture of the catalyst, dependent on the size of the formation of pyrochloric oxides, said oxides can be present as crystalline tin-containing phase in addition to the above mentioned roentgenographically amorphous tin oxide phase.

Also the addition of boron oxide can be advantageous for the sulfur tolerance of the catalysts.

The term “boron oxide” comprises all oxides, suboxides and hydroxides of the element boron.

Preferably, the boron oxide is impregnated onto the carrier oxide, preferably from an aqueous boric acid, either separately or together with at least one of the above mentioned compounds, i.e. a compound of tin, platinum or of a promoter. Thereby, boric oxide is homogeneously dispersed on the surface of the catalyst.

Further, the catalyst is also characterized in that it can contains promoters selected from the group indium oxide, gallium oxide, alkali metal oxide, earth alkali metal oxide and rare earth element oxide.

Therefore, the process for the manufacture of the catalyst contains also the step (iv):
(iv) doping of the catalyst with a promoter.

If gallium oxide, indium oxide, alkali metal oxides, earth alkali metal oxides and rare earth element oxides are to be used, these compounds are also preferably applied in form of compounds, which are at least partially soluble in water.

Preferably, the promoters are used in form of the nitrates thereof. For example, the nitrates of the rare earth elements are accessible in the technical scale by dissolving the carbonates thereof in nitric acid. The use of nitrates is particularly advantageous, if the promoters are applied onto the carrier oxide simultaneously together with the nitrate-containing compounds of the tin and of the palladium.

Preferably, a process is used for the manufacture of the catalyst, where the starting materials of the promoters are brought into contact with the carrier oxide by means of an aqueous medium.

The compounds can be added in step (i). However, it is also possible to add them at a time, where the carrier oxide or the shaped body preferably was already coated according to one of the above methods (α), (β), (δ) and (γ).

It is also possible to add them together or after the compounds of the metals of the platinum group, i.e. platinum, rhodium, iridium and ruthenium.

After the application of the promoters, as the case may be, in turn a drying and/or calcination step is subsequently carried out.

In the following, the chemical composition of the catalysts according to the invention is described. The weight proportions in % are based on the element mass of tin, palladium or the other elements of the metals of the platinum group and the promoters, respectively. For the carrier oxides as well as for the zeolites, the weight proportions are based on the respective oxidic compounds.

The catalyst contains a total amount of from 3-50 weight-% tin oxide (calculated as tin) based on the total amount of all applied carrier oxides, wherein a total amount of 5-40 weight-% tin oxide is preferred.

The total amount of palladium, platinum, rhodium, iridium and ruthenium related to the total amount of all used carrier oxides preferably is of from 0.2-10 weight-%. More preferred is a total amount of from 0.5-5 weight-%.

The following weight proportions are based on the element masses of the respective elements.

The weight proportion of tin oxide (calculated as tin) to the sum of the weight of palladium, platinum, rhodium, iridium and ruthenium is preferably in a range of from 2:1 to 25:1, wherein a weight proportion in a range of 4:1 to 20:1 is more preferred. Still more preferred is a weight proportion in a range of from 6:1 to 15:1.

If platinum is additionally applied to palladium, then the weight proportion of palladium to platinum preferably is in a range of from 0.3:1 to 1000:1. More preferred is a range of from 1:1 to 50:1.

If rhodium, ruthenium, iridium or mixture thereof are applied in place of platinum, then the weight proportion of palladium to rhodium, ruthenium, Iridium or a mixture thereof preferably is in a range of from 2.5:1 to 1000:1. More preferred is a range of from 5:1 to 20:1.

If platinum and at least one further metal of the platinum group is additionally applied to palladium, then the weight proportion of palladium to the sum of platinum and the at least one further metal preferably is of from 0.3:1 to 1000:1. More preferred is a range of from 1:1 to 50:1.

If promoters are applied, then the weight proportion of tin oxide (calculated as tin) to the sum of all promoters (calculated as elements) is in a range of from 0.66:1 to 33:1. More preferred is a range of from 0.8:1 to 10:1. Still more preferred is a weight proportion in a range of from 1:1 to 6:1.

If boron oxide is applied, then the weight proportion of all applied carrier oxides to boron oxide (calculated as boron) is in a range of from 1:0.00005 to 1:0.2. More preferred is a range of from 1:0.0001 to 1:0.1. Still more preferred is a range of from 1:0.00002 to 1:0.075.

If a zeolite is applied, then the total amount of zeolites based on the total amount of all applied carrier oxides preferably is of from 5 to 50 weight-%. More preferred is a total amount of zeolite in a range of from 8 to 40 weight-%. In particular preferred is a range of from 10 to 25 weight-%.

In another embodiment, the object according to the invention could also be achieved with a catalyst, which contains a nanoparticular carrier oxide, onto which tin oxide and palladium are applied.

Thereby, the terms “tin oxide” and “palladium” have the same meaning as defined above.

Preferably, the term “carrier oxide” encompasses an oxide, which is thermally stable and which has a large surface. The term “carrier oxide” also encompasses a mixture of at least two different carrier oxides. Also the corresponding hydroxides or water-containing oxides are included, for example aluminum oxyhydroxide as for example the boehmite.

For the carrier oxide, the term “nanoparticular” has the meaning that its particle size is between 0.5 and 250 nm. In particular preferred is a particle size range of the nanoparticular carrier oxide between 5 and 180 nm.

For example, the particle size can be determined by means of light dispersion according to known methods. Thereby, the particles are present in a particle size distribution. Thereby, the particle size is mostly characterized by the d₅₀ value, which defines that 50% of the particles have the indicated diameter.

Nanoparticular carrier oxides have a relatively high outer surface compared to conventional carrier oxides, whose particle sizes are in the micrometer range. The outer surface can be evaluated by means of the following equation:
Outer surface=4*π*(d_{Partikel}/2)².

Therein, “d” has the meaning of the particle diameter. It is also possible to determine the surface of the nanoparticular carrier oxides of the present invention by the known BET method. In general, the particles have a BET surface of preferably more than 10 m²/g. It is more preferred that the nanoparticular carrier oxides have a BET surface of more than 50 m²/g. In particular, the surface is in the range between from 70 to 400 m²/g. The surface which was determined according to the BET method in general provides values, which deviates from the calculated values of the outer surface.

Preferably, nanoparticular carrier oxides are employed, which still have a high BET surface after exposure to high temperature.

Preferably, the nanoparticular carrier oxide contains silicon or aluminum or silicon and aluminum.

It is in particular preferred that the nanoparticular carrier oxide contains aluminum.

An aluminum-containing carrier oxide is a carrier oxide, which in particular contains aluminum oxide, silicon/aluminum mixed oxide, aluminum silicate or mixtures thereof.

Besides, also nanoparticular carrier oxides can be used, which are doped with silicon oxide, with oxides of the earth alkali elements or of the rare earth elements.

The processes for the manufacture of nanoparticular carrier oxides are known. For example, such processes include controlled precipitation processes, the hydrolysis of fatty alcohols and sol gel processes. Other methods for the manufacture of nanoparticular oxides consist in the flame treatment by pyrolysis of appropriate starting materials, as for example silicon tetrachloride, in rotary furnaces or pulsation reactors by means of deposition from the gas phase. Also, conventional carrier oxides can be transferred by means of chemical treatment, which are known processes, as for example by treatment with nitric acids into oxides, which contain nanoparticles and which can be used as carrier oxides.

Also, nanoparticular carrier oxides are commercially available. For example, informations concerning the properties thereof can be taken from the product data sheets of the manufacturer or from the patent applications or patents EP 1 359 123 A2, EP 0 931 017 B1 and WO 00/76643 A1.

Examples for nanoparticular carrier oxides, which are applicable for the invention, however the present invention is not restricted to, are the following commercially available oxides:

Disperal (Company Sasol), Disperal S (Company Sasol), Disperal HP 14 (Company Sasol), Disperal 40 (Company Sasol), Disperal AL 25 (Company Sasol), Dispal 11N7-12 (Company Sasol), Dispal 14N4-25 (Company Sasol), Dispal 18N4-20 (Company Sasol), Dispal 23N4-20 (Company Sasol), Disperal P2 (Company Sasol), Disperal HP 14/2 (Company Sasol), Dispal 11N7-80 (Company Sasol), Dispal 14N4-80 (Company Sasol), Dispal 18N4-80 (Company Sasol), Dispal 23N4-80 (Company Sasol).

Exemplarily, some characteristics of some of the before mentioned nanoparticular carrier oxides are listed. The informations correspond to the informations of the manufacturer. Thereby, the d₅₀ value means that 50% of the particles have the mentioned diameter.

| Carrier oxide | Particle size (d₅₀) [nm] | BET surface [m²/g] |
|---|---|---|
| Disperal S | 100* | 180** |
| Disperal 40 | 140* | 100** |
| Disperal AL 25 | 200* | 100** |
| Disperal P2 | 25* | 260** |

*dispersed in water or aqueous diluted HNO₃
**after drying and calcination for 3 hours at 550° C.

According to the informations of the manufacturer, conventional carrier oxides like Puralox SCFa (90-210) (Company Sasol) or Puralox (NGa) (80-160) (Company Sasol) have particle sizes (d₅₀) of approximately 20 or 35 μm and BET surfaces of approximately 90-210 m²/g or 80-160 m²/g.

It is also possible to apply mixtures of nanoparticular carrier oxides.

For example, the very preferred aluminum-containing nanoparticular carrier oxide can be mixed with other nanoparticular carrier oxides as for example silicon-containing, titanium-containing, cerium-containing, zirconium-containing or iron-containing carrier oxides. Examples for such silicon-containing or titanium-containing nanoparticular carrier oxides are:

Ludox AS40 (Company Dupont), Ludox CL (Company Dupont), Ludox TMA (Company Dupont), Hombicat XXS 100 (Company Sachtleben), Aerosil 150 (Company Degussa).

It is also possible to mix the nanoparticular carrier oxide, in particular the very preferred aluminum-containing nanoparticular carrier oxide, with conventional, i.e. non-nanoparticular carrier oxides, as described below, for example with silicon-containing, titanium-containing, cerium-containing, zirconium-containing or iron-containing carrier oxides. Examples for such conventional carrier oxides, where the particle sizes are in the micrometer range as mentioned above, are the following commercially available oxides:

Siralox 10/320 (Company Sasol), Siralox 5/170 (Company Sasol), Puralox SCFa 140 (Company Sasol), F50 (Company Dorfner), F80 (Company Dorfner), F+5/24 (Company Dorfner), F+5/48 (Company Dorfner), F-5/24 (Company Dorfner), F+10/2 (Company Dorfner), F+20/2 (Company Dorfner), SIAL 35 (Company Dorfner) SIAL 25-H (Company Dorfner), SA 3*77 (Company Norton), SA 5262 (Company Norton), SA 6176 (Company Norton), Alumina HiQR10 (Company Alcoa), Alumina HiQR30 (Company Alcoa), Korund (Company Alcoa), MI307 (Company Grace Davison), MI407 (Company Grace Davison), MI286 (Company Grace Davison), MI386 (Company Grace Davison), MI396 (Company Grace Davison), MI486 (Company Grace Davison), calcinated Hydrotalzit Pural MG70 (Sasol), calcinated Hydrotalzit Pural MG50 (Sasol), Sident 9 (Company Degussa), Sipernat C 600 (Company Degussa), Sipernat 160 (Company Degussa), Ultrasil 360 (Company Degussa); Ultrasil VN 2 GR (Company Degussa), Ultrasil 7000 GR (Company Degussa), Kieselsäure 22 (Company Degussa), P 25 (Company Degussa), XT 25384 (Company Norton), XT 25376 (Company Norton), Cer(IV)-Oxid (Company Merck), XZ 16052 (Company Norton), XZ 16075 (Company Norton).

Additionally to the mentioned oxides, the nanoparticular carrier oxide can also contain admixtures of one or more zeolites. The before disclosed zeolites can be used.

Examples for zeolites, which are applicable for the invention, however the present invention is not restricted to, are:

Mordenit HSZ®-600 (Company Tosoh), Ferrierit HSZ@-700 (Company Tosoh), HSZ@-900 (Company Tosoh), USY HSZ@-300 (Company Tosoh), DAY Wessalith HY25/5 (Company Degussa); ZSM-5 SiO₂/Al₂O₃ 25-30 (Company Grace Davison), ZSM-5 SiO₂/Al₂O₃ 50-55 (Company Grace Davison), β-zeolite HBEA-25 (Company Süd-Chemie), HBEA-150 (Company Süd-Chemie), P 814C (Company Zeolyst), CP 814E (Company Zeolyst), Zeocat FM-8/25H (Company Zeochem), Zeocat PB/H (Company Zeochem).

If, for example, only one carrier oxide is used, which is present only partially in form of nanoparticles, then it is preferred that at least 3 weight-% of the carrier material are present in form of nanoparticles. It is more preferred that at least 10 weight-% are present in form of nanoparticles.

If the nanoparticular carrier oxide is used in combination with other carrier oxides and/or zeolites, which are not present as nanoparticles, then it is also preferred that at least 3 weight-%, more preferred at least 10 weight-% of the total carrier material is present in form of nanoparticles.

The catalyst according to this embodiment is manufactured according to a process, which relates to the process as described above, whereby the carrier oxide is nanoparticular.

Further process steps include the above steps of the calcination (ii) as well as the doping steps (iii) and (iv).

The respectively mentioned compounds and reaction conditions are used.

Consequently, the use of a dopant is possible with one or more elements from the group platinum, rhodium, iridium or ruthenium.

Also doping with one or more promoters selected from the group indium oxide, gallium oxide, iron oxide, alkali metal oxide, earth alkali metal oxide and rare earth element oxide is possible.

It should be mentioned that in the before mentioned embodiments (α), (β), (γ) and (δ) in place of a nanoparticular carrier oxide also mixtures of nanoparticular carrier oxides can be employed. Also, it is possible to admix one or more conventional, i.e. non-nanoparticular carrier oxides to a nanoparticular carrier oxide or to a mixture of nanoparticular carrier oxides. As a rule, for this case, the carrier oxide suspension is subjected to a grinding process before the coating onto the shaped body in order to ensure a good adhesion of the carrier oxides on the shaped body. Furthermore, in all embodiments one or more zeolites of the nanoparticular carrier oxide suspension can be added.

By means of the calcination step, the nanoparticular carrier oxides can agglomerate partially to bigger particles. In general, this does not affect the efficiency of the catalysts or does only marginally affect the efficiency. The high dispersity of the tin oxide, of the palladium and optionally of the added promoters, in general, is maintained as far as possible.

If a promoter is used, then said promoter is dispersed on the surface of the catalyst in a manner that it is homogeneously dispersed together with the tin oxide and the palladium. When using a zeolite in the washcoat, which is capable for ion exchange, then, said promoters can accumulate in said zeolite.

Besides the addition of boron oxide, also the addition of phosphorous oxide can be advantageous for the sulfur tolerance of the catalysts.

The term “phosphorous oxide” comprises all oxides, suboxides and hydroxides of the element phosphorous.

Preferably, the phosphorous oxide is impregnated onto the carrier oxide from an aqueous phosphoric acid, either separately or together with at least one of the before mentioned compounds, i.e. a compound of the tin, of the platinum or of a promoter. Thereby, the phosphorous oxide is homogeneously dispersed on the surface of the catalyst.

For the manufacture of the catalyst it is not excluded that both boron oxide and phosphorous oxide are added.

In the following, the chemical composition of the catalysts according to the invention is disclosed. Weight-% is based on the respective element mass of the tin, of the palladium or the other elements of the metals of the platinum group and of the promoters. For the carrier oxides as well as for the zeolites, the weight proportions is based on the corresponding oxidic compounds.

The catalyst contains a total amount of 3-100 weight-% of the nanoparticular carrier oxide based on the total amount of all employed carrier oxides, wherein a total amount of 10-100 weight-% is preferred.

The catalyst contains a total amount of from 3-50 weight-% tin oxide (calculated as tin) based on the total amount of all applied carrier oxides, wherein a total amount of 5-40 weight-% tin oxide is preferred.

The total amount of palladium, platinum, rhodium, iridium and ruthenium based on the total amount of all used carrier oxides preferably is of from 0.2-10 weight-%. More preferred is a total amount of from 0.4-5 weight-%.

The following specifications to weight proportions are based on the element masses of the corresponding elements.

The weight proportion of tin oxide (calculated as tin) to the sum of the weight of palladium, platinum, rhodium, iridium and ruthenium preferably is in a range of from 2:1 to 50:1, wherein a weight proportion in a range of from 4:1 to 45:1 is more preferred. Still more preferred is a weight proportion in a range of from 5:1 to 40:1.

If platinum is additionally applied to palladium, then the weight proportion of palladium to platinum preferably is in a range of from 0.3:1 to 1000:1. More preferred is a range of from 1:1 to 50:1.

If rhodium, ruthenium, iridium or mixture thereof are applied in place of platinum, then the weight proportion of palladium to rhodium, ruthenium, Iridium or a mixture thereof preferably is in a range of from 2.5:1 to 1000:1. More preferred is a range of from 5:1 to 20:1.

If platinum and at least one further metal of the platinum group is additionally applied to the palladium, then the weight proportion of palladium to the sum of platinum and the at least one further metal preferably is of from 0.3:1 to 1000:1. More preferred is a range of from 1:1 to 50:1.

If promoters are applied, then the weight proportion of tin oxide (calculated as tin) to the sum of all promoters (calculated as elements) is in a range of from 2:1 to 50:1. More preferred is a range of from 4:1 to 45:1. Still more preferred is a weight proportion in a range of from 7:1 to 35:1.

If boron oxide is applied, then the weight proportion of all applied carrier oxides to boron oxide (calculated as boron) is in a range of from 1:0.00005 to 1:0.2. More preferred is a range of from 1:0.0001 to 1:0.1. Still more preferred is a range of from 1:0.00002 to 1:0.075.

If phosphorous oxide is applied, then the weight proportion of all applied carrier oxides to phosphorous oxide (calculated as P) is in a range of from 1:0.00005 to 1:0.2. More preferred is a range of from 1:0.0001 to 1:0.1. Still more preferred is a range of from 1:0.0002 to 1:0.075.

If a zeolite is applied, then the total amount of zeolites based on the total amount of all applied carrier oxides preferably is of from 5 to 70 weight-%. More preferred is a total amount of zeolite in a range of from 8 to 60 weight-%. In particular preferred is a range of from 10 to 50 weight-%.

Preferably, the tin oxide and the palladium are very homogeneously dispersed over the surface of the nanoparticular carrier oxide.

The homogeneity of the distribution of tin and palladium on the carrier oxide can be described thereby that preferably
(3) tin and palladium—by consideration of the individual particles—are distributed in approximately constant concentrations over the particles of the carrier oxide, respectively, and
(4) the concentration proportions—by consideration of the individual particles—of tin to carrier oxide as well as the concentration proportions of tin to palladium on the surface of the particles of the carrier oxide are approximately constant.

Said dispersion also includes that the catalyst for example contains a mixtures of at least two tin- and palladium-containing carrier oxides, which have different tin and/or palladium concentrations, respectively. Further, said distribution also includes that the carrier oxide is manufactured according to the process of the gradient coating. In case of a gradient coating, a gradient—for example of the palladium, the tin, a promoter or boron oxide—is adjusted for example across the length of a honeycomb body, which is used for the manufacture of the catalyst, as already discussed above.

Preferably, the term “gradient coating” relates to a gradient in the chemical composition.

As measuring method for the verification of the homogeneity, the known REM/EDX-method (scanning electron microscopy/energy disperse X-ray micro-analysis) can be used.

Furthermore, the use of a nanoparticular carrier oxide in the manufacture of the catalyst results in that tin oxide, palladium, and optionally promoters are present on the carrier oxide in a highly dispersed phase. This has proved to be extraordinarily favorable for the intended purpose. Without being bound to a theory, it is assumed that with increasing dispersity of the active phase of the catalyst, that is the tin oxide and the palladium, also the number of the atoms increases, which can come into contact with the reaction gas, whereby also the catalytical activity of the catalyst increases.

As a measuring method for the verification of the dispersity of the tin oxide, of the palladium and optionally of the promoters on the nanoparticular carrier oxide, the transmission electron microscopy (TEM) can be consulted, also in combination with the EDX-method.

The tin oxide, which is deposited onto the nonoparticular carrier oxide, preferably has a roentgenographically amorphous or a nanoparticular form.

Preferably, the palladium is also present in a roentgenographically amorphous or a nanoparticular form.

The fresh catalysts, that is the catalysts which are calcinated at 500° C., have tin oxide particle sizes, which are determined according to the Scherrer method, preferably, of from about 1 to 100 nm, whereby the particle sizes of the tin oxide can depend from the used carrier oxide. In some cases even no reflexes of the tin oxide can be detected, so that the tin oxide, which is present on said catalyst, can be termed as “roentgenographically amorphous”. After aging at 700° C., dependent from the used carrier oxide, no or only a very little agglomeration of the tin oxide particles can be detected. This outlines the very good durability of the catalysts according to the invention.

The term “nanoparticular” means for the tin oxide, that the particle size, which is determined according to the Scherrer equation, preferably is below 100 nm. A range of from 0.5 and 100 nm is preferred. More preferred is that the particle size is below 50 nm. In particular preferred is a particle size range of the tin oxide between 1 and 50 nm.

Also the palladium particles can be present in the before described particle size ranges.

The term “roentgenographically amorphous” shall mean that no reflexes, which are characteristic for a substance can be obtained by means of X-ray deflection.

The term “roentgenographically amorphous” shall also mean that the particle size of the tin oxide and/or of the palladium can be in the atomic range.

Surprisingly, the roentgenographically amorphous or nanoparticular form of the tin oxide is maintained for a high loading of the carrier oxide with tin.

The catalyst of the present invention differs from the tin oxide-containing catalysts of the prior art inter alia thereby that
e) a carrier oxide is applied in nanoparticular form,
f) tin oxide and palladium are present in direct topographical proximity together on a carrier oxide particle,
g) during the manufacture of the catalyst the tin oxide is brought into contact with a carrier oxide in form of a dissolved or at least partially dissolved precursor.

Other essential differences compared to the catalysts of the prior art are achieved by a relatively high loading of the carrier oxide with tin oxide, by the selection of the weight proportions of the components which are contained in the catalyst, by the high dispersity of tin oxide and palladium respectively the nanoparticular or roentgenographically amorphous properties as well as by the processes for the manufacture of the catalyst which are disclosed before.

The catalysts of the invention preferably have a structure in which macro pores exist having ducts, which coexist with meso pores and/or micro pores.

The invention also relates to the use of the catalysts for the removal of harmful substances from exhaust gases of lean combustion engines and exhaust air.

Furthermore, the present invention also relates to a process for the purification of exhaust gases of lean combustion engines, in particular of Diesel engines, and exhaust airs by using the before disclosed catalyst.

Preferably, the process for the purification of exhaust gas is carried out in a manner that said purification of exhaust gas comprises the simultaneous oxidation of hydrocarbons and carbon monoxide as well as the removal of carbon black by oxidation.

The catalysts can also be run in combination with at least one other catalyst or carbon black particle filter. Thereby, for example, the carbon black particle filter can be coated with the catalyst. The combination of the catalyst according to the invention with another catalyst is conceivable (αα) by a sequential arrangement of the different catalysts, (ββ) by the physical mixture of the different catalysts and application onto a common shaped body or (γγ) by application of the different catalysts in form of layers onto a common shaped body, as well as by any combination thereof.

Preferably, the carbon black particle filter itself is coated with the oxidation catalyst.

In the following, the manufacture of exemplified catalysts is illustrated as well as the properties thereof compared to the prior art. The fact that this is carried out with concrete examples by indication of concrete values shall in no case be under-stood as limitation of the specifications, which are made in the description and in the claims.

Examples of the Embodiment of the Catalyst, in which Tin Oxide and Palladium are Present in Roentgenographically Amorphous or Nanoparticular Form:

In the figures show:

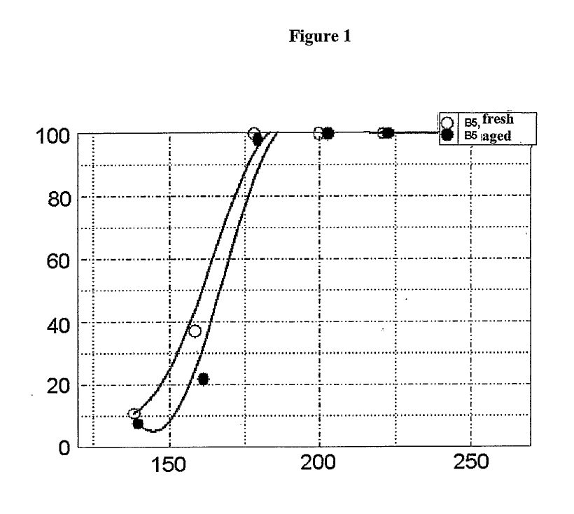

FIG. 1 the CO-conversion versus reaction temperature of the catalyst sample according to Example 5 (B5), which had the composition Pd₁.4Pt_{0.6}Sn₅/Siralox, in the fresh state and after thermal aging for 16 hours at 700° C. In FIG. 1, in the horizontal axis the temperature is plotted in the unit ° C. and in the vertical axis the CO-conversion in the unit %.

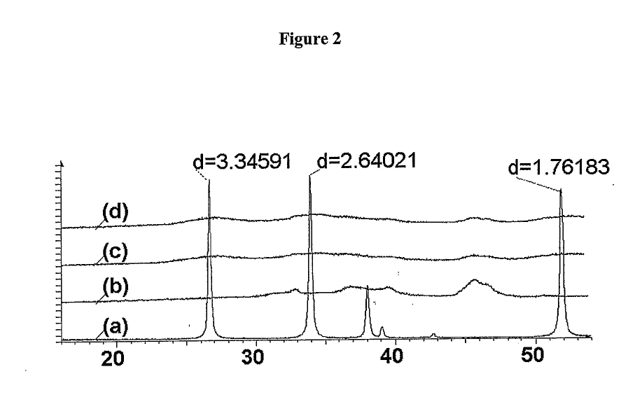

FIG. 2 the diffraction analysis of the following samples: (a) VB2, (b) unloaded carrier oxide Siralox 5/170, (c) B31 (fresh) and (d) B31 (aged). In FIG. 2, the horizontal axis presents the 2-theta scale in the unit degree, and the vertical axis presents the intensity of the X-ray in arbitrarily selected unit.

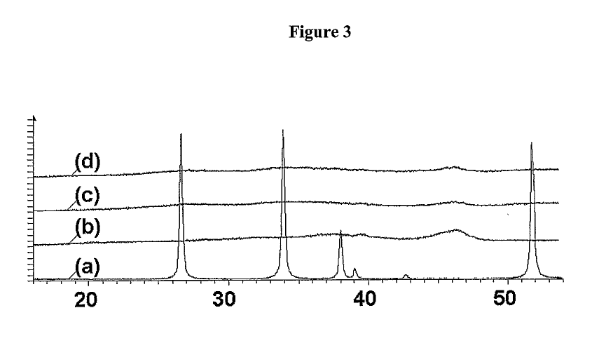

FIG. 3 the diffraction analysis of the following samples: (a) VB2, (b) unloaded carrier oxide Siralox 5/320, (c) B24 (fresh) and (d) B24 (aged). In FIG. 3, the horizontal axis presents the 2-theta scale in the unit degree, and the vertical axis presents the intensity of the X-ray radiation in arbitrarily selected unit.

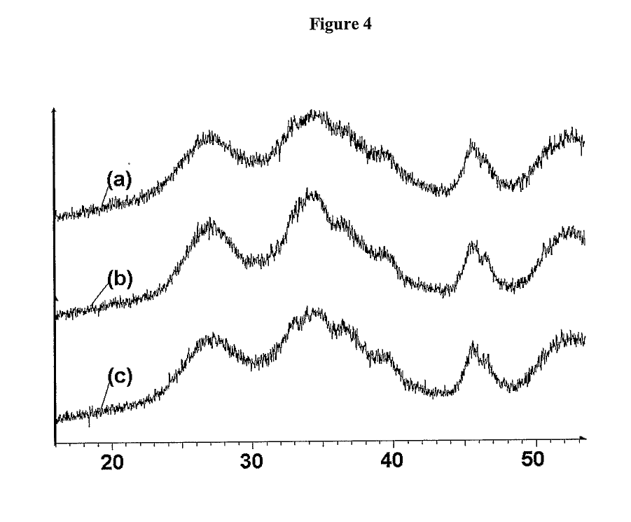

FIG. 4 the diffraction analysis of the catalyst from Example B31 after different pre-treatments steps: (a) fresh sample, (b) aged sample and (c) the fresh sample after catalytical testing. Siralox 5/170 was applied as carrier oxide. In FIG. 4, the horizontal axis presents the 2-theta scale in the unit degree, and the vertical axis presents the intensity of the X-ray radiation in arbitrarily selected unit.

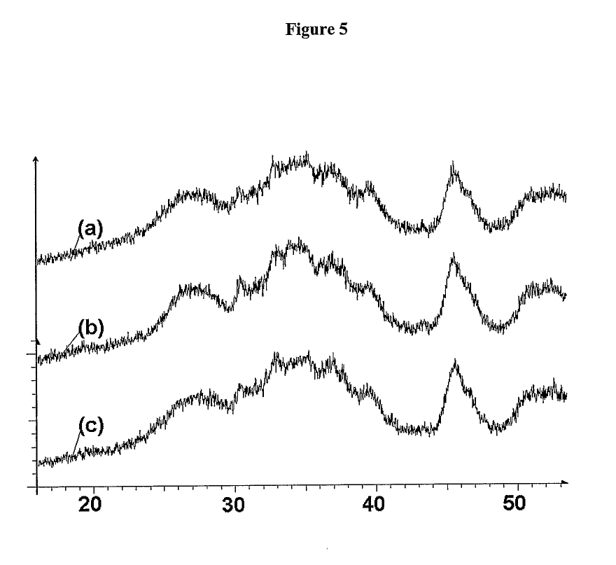

FIG. 5 the diffraction analysis of the catalyst from Example B37 after different pre-treatment steps: (a) fresh sample, (b) aged sample and (c) the fresh sample after catalytical testing. Puralox SCFa 140 was applied as carrier oxide. In FIG. 5, the horizontal axis presents the 2-theta scale in the unit degree, and the vertical axis presents the intensity of the X-ray radiation in arbitrarily selected unit.

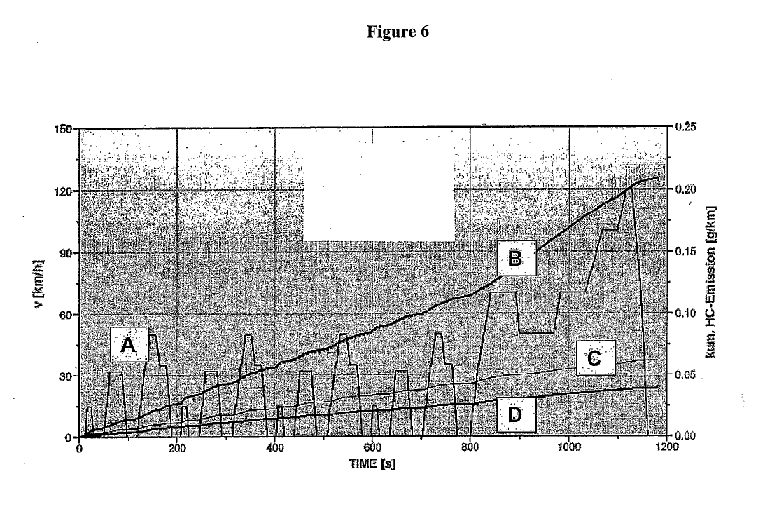

FIG. 6 the cumulated HC emissions of the catalyst according to Example B153, which were obtained on the engine test station in the new European vehicle cycle. The horizontal axis presents the time in seconds, the vertical axis the velocity or the cumulated HC-emissions. Thereby, A illustrates the change of the engine load in dependence from the time, B the cumulated HC emission without catalyst, C the cumulated HC emission using the reference catalyst, D the cumulated HC emission using the catalyst according to the invention.

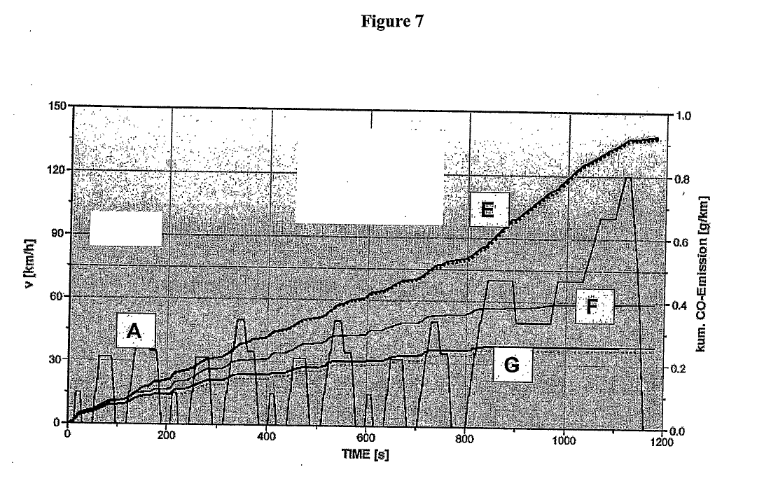

FIG. 7 the cumulated CO emissions of the catalyst according to Example B153, which were obtained on the engine test station in the new European vehicle cycle. The horizontal axis shows the time in seconds, the vertical axis the velocity respectively the cumulated CO-emissions. Thereby, A illustrates the change of the engine load in dependence from the time, E the cumulated CO emission without catalyst, F the cumulated CO emission using the reference catalyst, G the cumulated CO emission using the catalyst according to the invention.

### CATALYTICAL TESTING

Activity measurements were carried out in a fully automated catalyst facility with 16 fixed bed reactors made from stainless steel (the inner diameter of an individual reaction chamber was 7 mm), which were run parallelly. The catalysts were tested under conditions, which were similar to Diesel exhaust gas, in a continuously operational mode with an oxygen surplus under the following conditions:

| | |
|---|---|
| Temperature range: | 120-400° C. |
| Exhaust gas composition: | 1000 vppm CO, 100 vppm propen, 300 vppm |
| | NO, 10% O₂, 6% H₂O, balance - N₂. |
| Gas flow rate: | 45 1/h per catalyst |
| Catalyst mass: | 0.125 g |

The majority of the catalysts were measured as bulk material, consisting of carrier oxide, tin oxide, palladium and optionally promoters and further metals from the platinum group, because the application of the washcoat onto a shaped body was mostly set aside. As a rule, a sieve fraction with particle sizes of from 315-700 μm was used for the measurement of the activity.

As reference catalysts (VB) a commercial honeycomb shaped oxidation catalyst for exhaust gases from Diesel engines was applied with 3.1 g/l (90 g/ft³) platinum. 0.52 g of said catalyst were mortared and were also used as bulk material for the measurements. The mass of the reference catalyst which was used for the measurements was clearly higher compared to the mass of the catalysts according to the invention, what was resulting from that the reference catalyst quasi was “diluted” by the honeycomb substrate. So, the comparison measurements between the catalysts according to the invention and the reference catalyst were carried out on the basis of approximately the same mass of noble metal.

The determination of CO, CO₂, propen and H₂O was carried out with a FT-IR-device of the Company Nicolet. O₂ was determined with a λ-sensor of the Company Etas, whereas the determination of NO, NO₂ and NOₓ was carried out with a chemoluminescence device of the Company Ecophysics.

For the evaluation of the catalysts, the T₅₀ values (temperature, where 50% conversion is achieved) was used as criteria for the CO and propen oxidation for the oxidation activity.

The T₅₀ values for the catalysts in fresh state as well as after the different aging processes (thermal aging, aging by sulfur, hydrothermal aging) are summarized in the Tables 3 to 8.

Aging by Sulfur

The term “aging by sulfur” (also sulfur tolerance or sulfur resistance)” describes the capability of an oxidation catalyst to oxidize CO and HC, which is contained in the exhaust gas, also after the influence of sulfur oxides (SOₓ) to CO₂ and H₂O.

The aging by sulfur was carried out in a 16-folded parallel reactor under the following conditions:

| | |
|---|---|
| Temperature: | 350° C. |
| Duration: | 16 hours |
| Gas composition: | 100 vppm SO₂, 5% H₂O, balance - synthetic |
| | air. |
| Gas flow rate: | 10 1/h per catalyst |
| Catalyst mass: | 0.125 g |

After the aging for 16 hours, the feeding of the SO₂ was terminated and the catalysts were cooled down under synthetic air.

Thermal Aging

The thermal aging of the catalysts was carried out in air in a muffle furnace at a temperature of 700° C. Thereby, the catalysts were kept for 16 hours at this temperature and were then cooled down to room temperature. Alternatively, selected catalysts were also aged in air at 850° C. and 1000° C.

Hydrothermal Aging

The hydrothermal aging was carried out in a muffle furnace at a temperature of 750° C. in an air stream, which contained 10% water. Thereby, the catalysts were kept for 16 hours at said temperature and were then cooled down to room temperature.

### EXAMPLES

### Example 1 (B1)

For the manufacture of the catalytically active material, a silica-alumina (Siralox 5/320) of the Company Sasol was suspended in water and was ground in a ball mill. After drying, 0.4 g of the ground material were provided as carrier oxide. 225 μl of an aqueous 0.75 molar solution, which consisted of tin oxalate and 30% nitric acid (HNO₃), were mixed with 100 μl of an aqueous HNO₃-containing 0.75 molar palladium nitrate solution [Pd(NO₃)₂ solution] and was diluted with 315 μl water. The carrier oxide was impregnated with 640 μl of said solution. The so impregnated carrier oxide was then dried for 16 hours at 80° C. in a drying oven. Subsequently, the material was calcinated for 2 hours at 500° C. in air in a muffle furnace (termed as “fresh”). Additionally, a portion thereof was calcinated for 16 hours at 700° C. in air (termed as “aged”).

The resulting loading of the carrier oxide was 2 weight-% palladium and 5 weight-% tin.

### Example 2 to 4 (B2-B4)

The catalysts were manufactured analogously to Example 1, whereby the carrier oxide was impregnated with an aqueous solution of tin oxalate, palladium nitrate and platinum nitrate, which was treated with HNO₃.

In Table 1 the compositions of the respective catalysts are given on basis of weight-%, whereby said specification relates to the elementary form of the noble metals and of the tin.

### Example 5

For the manufacture of the catalytic active material, silica-alumina (Siralox 5/320) of the Company Sasol was suspended in water and was ground in the ball mill. After drying, 0.5 g of the ground material were provided as carrier oxide.

The application of the active component onto the carrier oxide was carried out in two steps. In the first step, the carrier oxide was impregnated with the 800 μl of aqueous HNO₃-containing solution which contained 211 μl tin oxalate and 66 μmol palladium nitrate, and dried. In the second step, the so impregnated carrier was impregnated with an aqueous solution, which contained 15 μmol platinum nitrate, and was dried for 16 hours at 80° C.

Subsequently, the material was calcinated for 2 hours at 500° C. in air (termed as “fresh”). Additionally, a portion thereof was calcinated for 16 hours at 700° C. in air (termed as “aged”).

The loading based on the amount of carrier oxide was 1.4 weight-% palladium, 0.6 weight-% platinum and 5 weight-% tin.

### Example 6

The catalyst was manufactured analogously to Example 5, wherein in the second impregnation step EA platinate (bis-ethanolammonium-hexahydroxo-platinate) was used in place of platinum nitrate.

### Example 7

For the manufacture of the catalytically active material, silica-alumina (Siralox 5/320) of Company Sasol was mixed with water and was ground in a ball mill. A suspension, which contained 0.5 g of the carrier oxide was mixed under stirring with 800 μl of an aqueous solution, which contained 211 μmol tin oxalate to which a little HNO₃ was added and 66 μmol palladium nitrate, which was dried and which was calcinated for 2 hours at 500° C. in air in the muffle furnace. Afterwards, the material was impregnated with an aqueous solution which contained 15 μmol EA platinate, and was dried for 16 hours at 80° C.

Subsequently, the material was calcinated for 2 hours at 500° C. in air (termed as “fresh”). Additionally, a portion thereof was calcinated for 16 hours in air at 700° C. (termed as “aged”).

The loading with additional components based on the amount of carrier oxide was 1.4 weight-% palladium, 0.6 weight-% platinum and 5 weight-% tin.

### Example 8

The catalyst was manufactured analogously to Example 1, whereby the carrier oxide was impregnated with aqueous HNO₃-containing solution of tin oxalate, palladium nitrate and platinum nitrate.

The loading related to the amount of carrier oxide was 1 weight-% palladium, 1 weight-% platinum and 5 weight-% tin.

### Example 9

The catalyst was manufactured analogously to Example 1, whereby the carrier was impregnated with an aqueous HNO₃-containing solution of tin oxalate, palladium nitrate and ruthenium-nitrosyl-trinitrate.

The loading based on the amount of carrier oxide was 1.8 weight-% palladium, 0.2 weight-% ruthenium and 5 weight-% tin.

### Examples 10 to 13 (B10-B13)

The catalysts were manufactured analogously to Example 1, whereby the carrier oxide was impregnated with an aqueous HNO₃-containing solution of tin oxalate, palladium nitrate, platinum nitrate and ruthenium-nitroyl-trinitrate.

### Examples 14 to 29 (B14-B29)

The catalysts were manufactured analogously to Example 1, whereby the carrier was loaded with different amounts of tin, palladium and platinum. The manufacture of catalysts with a high loading with tin was carried out in two or three impregnation steps.

### Example 30 (B31)

For the manufacture of the catalytically active material, silica-alumina (Siralox 5/170) of the Company Sasol was suspended in water and was ground in a ball mill. After the drying, 2 g of the ground material were provided as carrier oxide.

9 ml of an aqueous HNO₃-containing solution, which contained 376 μmol palladium nitrate and 1685 μmol tin oxalate, were mixed with the carrier oxide and were dried in circulating air. Subsequently, the material was calcinated for 2 hours at 500° C. in air (termed as “fresh”). Additionally, a portion thereof was calcinated for 16 hours at 700° C. in air (termed as “aged”).

The loading based on the amount of carrier oxide was 2 weight-% palladium and 20 weight-% percent tin.

### Example 31 (B31)

For the manufacture of the catalytically active material, silica-alumina (Siralox 5/170) of Company Sasol was suspended in water and was ground in the ball mill. After the drying, 2 g of the ground material were provided as carrier.

The application of the active component onto the carrier oxide was carried out in two steps. In the first step, the carrier oxide was impregnated with the 9 ml of an aqueous HNO₃-containing solution, which contained 1685 μmol tin oxalate, and was dried in circulation air. In the second step, the so impregnated carrier oxide was impregnated with an aqueous solution, which contained 376 μmol palladium nitrate, and was dried for 16 hours at 80° C. Subsequently, the material was calcinated for 2 hours at 500° C. in air (termed as “fresh”). Additionally, a portion thereof was calcinated for 16 hours at 700° C. in air (termed as “aged”).

The loading based on the amount of carrier oxide was 2 weight-% palladium and 20 weight-% tin.

### Examples 32 to 36 (B32-B36)

The catalysts were manufactured analogously to Example 30, whereby the loading with palladium and tin was varied.

### Examples 37 to 47 (B37-B47)

The catalysts were manufactured analogously to Example 30, whereby Puralox SCFa 140 of Company Sasol was used as carrier and the composition of the active components was varied (see Table 1).

### Examples 48 to 106 (B48-B106)

The catalysts were manufactured analogously to Example 1, whereby different carriers containing alumina and silica as well as physical mixtures of oxidic carriers and zeolites were impregnated with aqueous HNO₃-containing solution of tin oxalate, palladium nitrate and platinum nitrate.

In Table 1, the used carrier oxides and the compositions of the formulations according to Example B1 to B 106 are given.

### Examples 107 to 117 (B107-B117)

The catalysts were manufactured according to Example 1, whereby the carrier oxide, Siralox 5/320, was impregnated with an HNO₃-containing solution of tin oxalate, palladium nitrate and a salt of a promoter and optionally boron acid.

In Table 2, the compositions of the corresponding catalysts are given.

### Examples 118 to 150 (B118-B150)

The catalysts were manufactured according to Example 30, whereby the carrier oxides in form of Puralox SCFa 140, Puralox SCFa 140/L3 (B149, B150) or a mechanical mixture of Puralox SCFa 140 and beta-zeolite (B143) were loaded with a HNO₃-containing solution of tin oxalate, palladium nitrate, ruthenium-nitrosyl-trinitrate (B127-B132) and a salt of a promoter.

In Table 2, the compositions of the corresponding catalysts are given on basis of weight-%, wherein these specifications relate to the elementary form of the noble metals, of the tin and of the promoter component.

### Example 151 (B151)

The catalyst according to this example was manufactured in a manner that the aluminum oxide was impinged with tin in the absence of the zeolite, and that the zeolite was admixed in a subsequent manufacturing step to the aluminum oxide/tin oxide composite. Furthermore, the catalyst was applied onto a honeycomb shaped carrier.

Thereby, 200 g aluminum oxide were mixed with 900 ml of an aqueous HNO₃-containing solution, which contained 0.17 mol tin oxalate and were dried in circulating air. Subsequently, the material was calcinated in air according to the methods described before.

Subsequently, the so-obtained tin aluminum composite was suspended in deionized water and was ground in a ball mill. Then, 40 g iron-containing zeolite were added to the suspension. The coating suspension was adjusted to a solid amount of 20 percent by weight by addition of deionized water.

As catalyst carrier, a honeycomb-shaped core made from Cordierit with 400 cpsi (channels per square inch) of Company NGK was used, which was cut before to a dimension of 1 inch in diameter and 2 inches in length.

The core was coated by means of several dunkings into the coating suspension with the alumina/tin composite and zeolite, whereby after each dunking step the ducts of the core were blown out in order to remove an excess of suspension. After each coating step, the core was dried in an air stream and was subsequently calcinated as described before. The washcoat loading was 130 g/l. Said loading represents the solids content of the washcoat after calcination, which was applied to the shaped body.

The application of the compound of the palladium was carried out by dunking the coated core into palladium nitrate solution. The concentration of the palladium nitrate solution was adjusted in a manner, that in one impregnation step 40 g/ft³ Pd could be applied. The so impregnated core was then dried in an air stream and was calcinated in an air stream.

For the synthesis gas measurements, the supported catalyst was carefully transferred into gritting material in a mortar.

### Example 152 (B152)

The catalyst according to this example is structured in form of a double layer.

For the manufacture of the first layer of the catalyst, 200 g of aluminum oxide were suspended in deionized water and was ground in a ball mill. The so-formed coating suspension had a solids content of 20 percent by weight. Said coating suspension presented very good adhesion properties and was applied without addition of further binder for the manufacture of the first coating of the washcoat.

As catalyst carrier, a honeycomb-shaped core made from Cordierit with 400 cpsi (channels per square inch) of company NGK was used, which was cut before to a dimension of 1 inch in diameter and 2 inches in length.

The core was coated by several dunkings into the coating suspension with the alumina washcoat, whereby after each dunking step the ducts of the core were blown out, in order to remove an excess of suspension. After each coating step, the core was dried in an air stream and subsequently was calcinated. The washcoat loading was 108 g/l. Said loading represented the solids content of the washcoat, which was applied to the shaped body, after calcination.

The application of the compound of the tin was carried out by dunking of the before coated core in a 0.5 molar tin oxalate solution. Subsequently, the core was dried in an air stream and was subsequently calcinated an air stream.

The first layer of the catalyst contained 108 g/l aluminum oxide and 9.5 g/l tin.

For the manufacture of the second layer of the catalyst, zeolite was suspended in deionized water and was ground in a ball mill. The thereby resulting coating suspension had a solids content of 20 percent by weight. For the improvement of the adhesion properties, a colloidal SiO₂ suspension was added.

Then, the core was coated with the second layer by repeated dunking into the zeolite suspension. After each dunking step, the ducts of the core were blown out in order to remove an excess of zeolite suspension, and the core was dried in an air stream. Subsequently, the coating was calcinated in an air stream. The loading with the second layer was 35 g/l. Said loading represents the solids content of the zeolite-containing washcoat, which was applied to the shaped body, after calcination.

The second layer of the catalyst contained 35 g/l zeolite and 1.05 g SiO₂.

The application of the palladium was carried out by dunking of the core into an aqueous palladium nitrate solution. Then, the core was dried in an air stream and was calcinated in a muffle type furnace in air (termed as “fresh”).

The completed catalyst contained 40 g/ft³ palladium.

For the synthesis gas measurements, the supported catalyst was carefully transferred into gritting material in a mortar.

### Example 153 (B153)

For measurements on an engine test station, a catalyst was manufactured according to Example 152. Thereby, the quantities were scaled up accordingly so that a supported catalyst with the dimensions 5.66″×6″ could be produced. The honey-comb-shaped carrier made from Cordierit was from the company NGK and had a cell density of 400 cpsi.

### Comparison Example 1 (VB1)

For comparison, an oxidation catalyst based on platinum with a platinum content of 3.1 g/l (90 g/ft³) (“reference catalyst”) was applied.

### Comparison Example 2 (VB2)

For comparison, a tin oxide catalyst which was loaded with Pd was used without carrier oxide. For the manufacture of said material, 1.5 g powdered tin oxide (Company Merck, order number 1,078,180,250) was provided and was impregnated with an aqueous HNO₃-containing palladium nitrate solution [Pd(NO₃)₂ solution]. The so impregnated tin oxide was then dried for 16 hours at 80° C. in the drying oven. Subsequently, the material was calcinated for 2 hours at 500° C. in air in the muffle furnace (termed as “fresh”). Additionally, a portion thereof was calcinated for 16 hours at 700° C. in air (termed as “aged”).

The resulting loading of the tin oxide was 2 weight-% palladium.

TABLE 1
Composition of the catalysts which are based on different carrier
oxides, amount and type of the active metal components of the
platinum group were varied in the manufacture thereof:

| | | Active component/weight-% | | | |
|---|---|---|---|---|---|
| Example | Carrier | Pd | Pt | Ru | Sn |
| B1 | Siralox 5/320 | 2 | 0 | | 5 |
| B2 | Siralox 5/320 | 1.8 | 0.2 | | 5 |
| B3 | Siralox 5/320 | 1.6 | 0.4 | | 5 |
| B4 | Siralox 5/320 | 1.4 | 0.6 | | 5 |
| B5 | Siralox 5/320 | 1.4 | 0.6 | | 5 |
| B6 | Siralox 5/320 | 1.4 | 0.6 | | 5 |
| B7 | Siralox 5/320 | 1.4 | 0.6 | | 5 |
| B8 | Siralox 5/320 | 1 | 1 | | 5 |
| B9 | Siralox 5/320 | 1.8 | | 0.2 | 5 |
| B10 | Siralox 5/320 | 1.62 | 0.18 | 0.,2 | 5 |
| B11 | Siralox 5/320 | 1.44 | 0.36 | 0.2 | 5 |
| B12 | Siralox 5/320 | 1.26 | 0.54 | 0.2 | 5 |
| B13 | Siralox 5/320 | 0.9 | 0.9 | 0.2 | 5 |
| B14 | Siralox 5/320 | 2 | 0 | | 10 |
| B15 | Siralox 5/320 | 1.8 | 0.2 | | 10 |
| B16 | Siralox 5/320 | 1.6 | 0.4 | | 10 |
| B17 | Siralox 5/320 | 1.4 | 0.6 | | 10 |
| B18 | Siralox 5/320 | 1 | 1 | | 10 |
| B19 | Siralox 5/320 | 2 | 0 | | 15 |
| B20 | Siralox 5/320 | 2 | 0 | | 20 |
| B21 | Siralox 5/320 | 1.95 | 0.05 | | 20 |
| B22 | Siralox 5/320 | 1.9 | 0.1 | | 20 |
| B23 | Siralox 5/320 | 1.8 | 0.2 | | 20 |
| B24 | Siralox 5/320 | 2 | 0 | | 30 |
| B25 | Siralox 5/320 | 2 | 0 | | 50 |
| B26 | Siralox 5/320 | 1 | 1 | | 15 |
| B27 | Siralox 5/320 | 1 | 1 | | 20 |
| B28 | Siralox 5/320 | 1 | 1 | | 30 |
| B29 | Siralox 5/320 | 1 | 1 | | 50 |
| B30 | Siralox 5/170 | 2 | | | 20 |
| B31 | Siralox 5/170 | 2 | | | 20 |
| B32 | Siralox 5/170 | 2 | | | 50 |
| B33 | Siralox 5/170 | 1 | | | 20 |
| B34 | Siralox 5/170 | 1 | | | 30 |
| B35 | Siralox 5/170 | 1 | | | 50 |
| B36 | Siralox 5/170 | 0.5 | | | 20 |
| B37 | Puralox SCFa 140 | 2 | | | 20 |
| B38 | Puralox SCFa 140 | 2 | | | 30 |
| B39 | Puralox SCFa 140 | 2 | | | 50 |
| B40 | Puralox SCFa 140 | 1 | | | 20 |
| B41 | Puralox SCFa 140 | 1 | | | 30 |
| B42 | Puralox SCFa 140 | 1 | | | 50 |
| B43 | Puralox SCFa 140 | 0.5 | | | 20 |
| B44 | Puralox SCFa 140 | 1.8 | | 0.2 | 20 |
| B45 | Puralox SCFa 140 | 1.9 | | 0.1 | 20 |
| B46 | Puralox SCFa 140 | 1.8 | | 0.2 | 20 |
| B47 | Puralox SCFa 140 | 1.9 | | 0.1 | 20 |
| B48 | Kaolin F + 20/2 | 2 | 0 | | 5 |
| B49 | Kaolin F + 20/2 | 1.8 | 0.2 | | 5 |
| B50 | Kaolin F + 20/2 | 1.6 | 0.4 | | 5 |
| B51 | Kaolin F + 20/2 | 1.4 | 0.6 | | 5 |
| B52 | Kaolin F + 20/2 | 1 | 1 | | 5 |
| B53 | Kaolin F + 20/2 | 2 | 0 | | 10 |
| B54 | Kaolin F + 20/2 | 1.8 | 0.2 | | 10 |
| B55 | Kaolin F + 20/2 | 1.6 | 0.4 | | 10 |
| B56 | Kaolin F + 20/2 | 1.4 | 0.6 | | 10 |
| B57 | Kaolin F + 20/2 | 1 | 1 | | 10 |
| B58 | Kaolin F + 20/2 | 1.8 | 0.2 | | 20 |
| B59 | Kaolin F + 20/2 | 1.9 | 0.1 | | 20 |
| B60 | Kaolin F + 20/2 | 1.95 | 0.05 | | 20 |
| B61 | Kaolin F + 20/2 | 2 | 0 | | 20 |
| B62 | 90% Puralox SCFa 140 | 2 | | | 20 |
| | 10% Beta-Zeolith | | | | |
| B63 | 90% Puralox SCFa 140 | 2 | 0 | | 20 |
| | 10% Wessalith HY25/5 | | | | |
| B64 | 50% Siralox 10/360 | 1.95 | 0.05 | | 20 |
| | 40% Kaolin F + 20/2 | | | | |
| | 10% Wessalith HY25/5 | | | | |
| B65 | 50% Siralox 10/360 | 2 | 0 | | 20 |
| | 40% Kaolin F + 20/2 | | | | |
| | 10% Wessalith HY25/5 | | | | |
| B66 | 90% Siralox 5/320 | 1.4 | 0.6 | | 5 |
| | 10% ZSM-5 | | | | |
| B67 | 90% Siralox 5/320 | 1 | 1 | | 5 |
| | 10% ZSM-5 | | | | |
| B68 | 90% Siralox 5/320 | 1.4 | 0.6 | | 10 |
| | 10% ZSM-5 | | | | |
| B69 | 90% Siralox 5/320 | 1 | 1 | | 10 |
| | 10% ZSM-5 | | | | |
| B70 | SiO₂ | 2 | 0 | | 5 |
| B71 | SiO₂ | 1.9 | 0.1 | | 5 |
| B72 | SiO₂ | 1.8 | 0.2 | | 5 |
| B73 | SiO₂ | 1.6 | 0.4 | | 5 |
| B74 | SiO₂ | 1 | 1 | | 5 |
| B75 | SiO₂ | 2 | 0 | | 10 |
| B76 | SiO₂ | 1.9 | 0.1 | | 10 |
| B77 | SiO₂ | 1.8 | 0.2 | | 10 |
| B78 | SiO₂ | 1.6 | 0.4 | | 10 |
| B79 | Kaolin F + 10/2 | 2 | 0 | | 5 |
| B80 | Kaolin F + 10/2 | 1.8 | 0.2 | | 5 |
| B81 | Kaolin F + 10/2 | 1.6 | 0.4 | | 5 |
| B82 | Kaolin F + 10/2 | 2 | 0 | | 10 |
| B83 | Kaolin F + 10/2 | 1.8 | 0.2 | | 10 |
| B84 | Kaolin F + 10/2 | 1.6 | 0.4 | | 10 |
| B85 | Kaolin F + 5/24 | 2 | 0 | | 5 |
| B86 | Kaolin F + 5/24 | 1.8 | 0.2 | | 5 |
| B87 | Kaolin F + 5/24 | 1.6 | 0.4 | | 5 |
| B88 | Kaolin F + 5/24 | 2 | 0 | | 10 |
| B89 | Kaolin F + 5/24 | 1.8 | 0.2 | | 10 |
| B90 | Kaolin F + 5/24 | 1.6 | 0.4 | | 10 |
| B91 | Sial 25-H | 2 | 0 | | 10 |
| B92 | Sial 25-H | 1.8 | 0.2 | | 10 |
| B93 | Sial 25-H | 1.6 | 0.4 | | 10 |
| B94 | Kaolin F − 5/24 | 2 | 0 | | 10 |
| B95 | Kaolin F − 5/24 | 1.8 | 0.2 | | 10 |
| B96 | Kaolin F − 5/24 | 1.6 | 0.4 | | 10 |
| B97 | Kaolin F | 2 | 0 | | 5 |
| B98 | Kaolin F | 1.8 | 0.2 | | 5 |
| B99 | Kaolin F | 2 | 0 | | 10 |
| B100 | Kaolin F | 1.8 | 0.2 | | 10 |
| B101 | Kaolin F | 1.6 | 0.4 | | 10 |
| B102 | Sial 35 | 2 | 0 | | 5 |
| B103 | Sial 35 | 1.8 | 0.2 | | 5 |
| B104 | Sial 35 | 2 | 0 | | 10 |
| B105 | Sial 35 | 1.8 | 0.2 | | 10 |
| B106 | Sial 35 | 1.6 | 0.4 | | 10 |

TABLE 2
Composition of the catalysts, which were manufactured with palladium or palladium and ruthenium as active components of the
metals of the platinum group, and which were doped in two different weight quantities with different components:

| | | Active component/weight-% | | | | | | | | | | | | | | | | | | | | | | |
|---|---|---|---|---|---|---|---|---|---|---|---|---|---|---|---|---|---|---|---|---|---|---|---|---|
| Example | Carrier | Pd | Ru | Sn | In | Ga | Fe | Zn | Ce | Yb | Hf | La | Ti | Sc | Y | Pr | Eu | Tb | Gd | Mg | Ca | Sr | Ba | B |
| B107 | Siralox 5/320 | 2 | | 20 | 2 | | | | | | | | | | | | | | | | | | | |
| B108 | Siralox 5/320 | 2 | | 20 | | 2 | | | | | | | | | | | | | | | | | | |
| B109 | Siralox 5/320 | 2 | | 20 | | | 2 | | | | | | | | | | | | | | | | | |
| B110 | Siralox 5/320 | 2 | | 20 | | | | 2 | | | | | | | | | | | | | | | | |
| B111 | Siralox 5/320 | 2 | | 20 | | | | | 2 | | | | | | | | | | | | | | | |
| B112 | Siralox 5/320 | 2 | | 20 | | | | | | 2 | | | | | | | | | | | | | | |
| B113 | Siralox 5/320 | 2 | | 20 | | | | | | | 2 | | | | | | | | | | | | | |
| B114 | Siralox 5/320 | 2 | | 20 | | | | | | | | 2 | | | | | | | | | | | | |
| B115 | Siralox 5/320 | 2 | | 20 | | | | | | | | | 2 | | | | | | | | | | | |
| B116 | Siralox 5/320 | 2 | | 20 | | 5 | | | | | | | | | | | | | | | | | | 0.5 |
| B117 | Siralox 5/320 | 2 | | 20 | | | | | | | | | | | | | 5 | | | | | | | 0.2 |
| B118 | Puralox SCFa 140 | 2 | | 20 | | | 5 | | | | | | | | | | | | | | | | | |
| B119 | Puralox SCFa 140 | 2 | | 20 | | | | 5 | | | | | | | | | | | | | | | | |
| B120 | Puralox SCFa 140 | 2 | | 20 | | | | | 5 | | | | | | | | | | | | | | | |
| B121 | Puralox SCFa 140 | 2 | | 20 | | | | | | | | 5 | | | | | | | | | | | | |
| B122 | Puralox SCFa 140 | 2 | | 30 | 5 | | | | | | | | | | | | | | | | | | | |
| B123 | Puralox SCFa 140 | 2 | | 30 | | | 5 | | | | | | | | | | | | | | | | | |
| B124 | Puralox SCFa 140 | 2 | | 30 | | | | 5 | | | | | | | | | | | | | | | | |
| B125 | Puralox SCFa 140 | 2 | | 30 | | | | | 5 | | | | | | | | | | | | | | | |
| B126 | Puralox SCFa 140 | 2 | | 30 | | | | | | | | 5 | | | | | | | | | | | | |
| B127 | Puralox SCFa 140 | 1.9 | 0.1 | 20 | | | | | | | | 5 | | | | | | | | | | | | |
| B128 | Puralox SCFa 140 | 1.9 | 0.1 | 20 | | | | | 5 | | | | | | | | | | | | | | | |
| B129 | Puralox SCFa 140 | 1.9 | 0.1 | 20 | | | | | | | | | | 5 | | | | | | | | | | |
| B130 | Puralox SCFa 140 | 1.9 | 0.1 | 20 | | | | | | | | | | | 5 | | | | | | | | | |
| B131 | Puralox SCFa 140 | 1.9 | 0.1 | 20 | | | | | | | | | | | | 5 | | | | | | | | |
| B132 | Puralox SCFa 140 | 1.9 | 0.1 | 20 | | | | | | | | | | | | | 5 | | | | | | | |
| B133 | Puralox SCFa 140 | 2 | | 20 | | | | | | | | | | | 5 | | | | | | | | | |
| B134 | Puralox SCFa 140 | 2 | | 20 | | | | | | | | | | | | | | 5 | | | | | | |
| B135 | Puralox SCFa 140 | 2 | | 20 | | | | | | | | | | | | 5 | | | | | | | | |
| B136 | Puralox SCFa 140 | 2 | | 20 | | | | | | | | | | | | | 5 | | | | | | | |
| B137 | Puralox SCFa 140 | 2 | | 20 | | | | | | 5 | | | | | | | | | | | | | | |
| B138 | Puralox SCFa 140 | 2 | | 20 | | | | | | | | | | | | | | | 5 | | | | | |
| B139 | Puralox SCFa 140 | 2 | | 20 | | | | | | | | | | | | | | | | 2 | | | | |
| B140 | Puralox SCFa 140 | 2 | | 20 | | | | | | | | | | | | | | | | | 2 | | | |
| B141 | Puralox SCFa 140 | 2 | | 20 | | | | | | | | | | | | | | | | | | 5 | | |
| B142 | Puralox SCFa 140 | 2 | | 20 | | | | | | | | | | | | | | | | | | | 5 | |
| B143 | 90% Puralox SCFa 140 | 2 | | 20 | | | | | | | | 5 | | | | | | | | | | | | |
| | 10% β- Zeolith | | | | | | | | | | | | | | | | | | | | | | | |
| B144 | Puralox SCFa 140 | 2 | | 20 | | | | | | | | 10 | | | | | | | | | | | | |
| B145 | Puralox SCFa 140 | 2 | | 20 | | | | | | | | | | | | | | 10 | | | | | | |
| B146 | Puralox SCFa 140 | 2 | | 20 | | | | | | | | | | | | 10 | | | | | | | | |
| B147 | Puralox SCFa 140 | 2 | | 20 | | | | | | | | | | | | | 10 | | | | | | | |
| B148 | Puralox SCFa 140 | 2 | | 20 | | | | | | | | | | | | | | | 10 | | | | | |
| B149 | Puralox SCFa 140/L3 | 2 | | 20 | | | | | | | | 5 | | | | | | | | | | | | |
| B150 | Puralox SCFa 140/L3 | 2 | | 20 | | | | | | | | | | | | | | 10 | | | | | | |

TABLE 3
Results of the catalytical testing of the CO and HC oxidation with
the fresh catalysts and with the catalysts which were aged at 700° C.:

| | |
|---|---|
| T₅₀ (CO) | T₅₀ (HC) |
| [° C.] | [° C.] |

| Example | fresh | aged | fresh | aged |
|---|---|---|---|---|
| B1 | 182 | 187 | 212 | 215 |
| B2 | 167 | 189 | 187 | 210 |
| B3 | 153 | 177 | 175 | 190 |
| B4 | 164 | 169 | 170 | 186 |
| B5 | 161 | 168 | 189 | 179 |
| B6 | 152 | 162 | 172 | 181 |
| B7 | 205 | 161 | 224 | 170 |
| B8 | 168 | 157 | 178 | 170 |
| B9 | 152 | 161 | 191 | 194 |
| B10 | 152 | 163 | 172 | 186 |
| B11 | 156 | 166 | 172 | 186 |
| B12 | 164 | 166 | 172 | 169 |
| B13 | 172 | 159 | 188 | 171 |
| B14 | 152 | 152 | 164 | 179 |
| B15 | 148 | 168 | 164 | 180 |
| B16 | 155 | 167 | 171 | 171 |
| B17 | 149 | 172 | 165 | 184 |
| B18 | 185 | 180 | 185 | 188 |
| B19 | 178 | 159 | 205 | 177 |
| B20 | 169 | 170 | 189 | 182 |
| B21 | 168 | 169 | 195 | 193 |
| B22 | 164 | 170 | 191 | 185 |
| B23 | 170 | 169 | 188 | 177 |
| B24 | 183 | 156 | 203 | 175 |
| B25 | 200 | 162 | 209 | 171 |
| B26 | 179 | 169 | 188 | 179 |
| B27 | 180 | 172 | 180 | 172 |
| B28 | 182 | 172 | 192 | 172 |
| B29 | 181 | 181 | 181 | 190 |
| B30 | 169 | 163 | 178 | 200 |
| B31 | 166 | 164 | 187 | 191 |
| B32 | 180 | 184 | 205 | 201 |
| B33 | 174 | 176 | 186 | 203 |
| B34 | 173 | 178 | 196 | 210 |
| B35 | 180 | 193 | 210 | 219 |
| B36 | 180 | 185 | 201 | 212 |
| B37 | 166 | 158 | 182 | 189 |
| B38 | 172 | 162 | 189 | 184 |
| B39 | 174 | 169 | 194 | 191 |
| B40 | 170 | 167 | 191 | 198 |
| B41 | 169 | 175 | 179 | 206 |
| B42 | 172 | 186 | 190 | 209 |
| B43 | 183 | 190 | 205 | 213 |
| B44 | 157 | | 179 | |
| B45 | 158 | | 182 | |
| B46 | 166 | | 184 | |
| B47 | 166 | | 185 | |
| B48 | 195 | 215 | 206 | 222 |
| B49 | 202 | 212 | 207 | 218 |
| B50 | 188 | 211 | 194 | 210 |
| B51 | 182 | 209 | 189 | 210 |
| B52 | 165 | 201 | 184 | 191 |
| B53 | 205 | 212 | 209 | 212 |
| B54 | 202 | 205 | 207 | 211 |
| B55 | 195 | 202 | 193 | 206 |
| B56 | 188 | 199 | 203 | 210 |
| B57 | 185 | 188 | 184 | 190 |
| B58 | 206 | 209 | 215 | 217 |
| B59 | 201 | 200 | 205 | 204 |
| B60 | 204 | 206 | 209 | 214 |
| B61 | 195 | 203 | 205 | 207 |
| B62 | 165 | 175 | 189 | 191 |
| B63 | 159 | 159 | 183 | 191 |
| B64 | 184 | | 197 | |
| B65 | 180 | | 193 | |
| B66 | 191 | 170 | 198 | 209 |
| B67 | 203 | 172 | 210 | 196 |
| B68 | 189 | 184 | 206 | 205 |
| B69 | 189 | 178 | 194 | 186 |
| B70 | 205 | 248 | 217 | 257 |
| B71 | 211 | 238 | 224 | 238 |
| B72 | 210 | 234 | 222 | 239 |
| B73 | 204 | 231 | 216 | 227 |
| B74 | 209 | 226 | 213 | 235 |
| B75 | 233 | 233 | 237 | 233 |
| B76 | 216 | 232 | 228 | 232 |
| B77 | 214 | 231 | 222 | 236 |
| B78 | 211 | 231 | 215 | 227 |
| B79 | 194 | 223 | 203 | 231 |
| B80 | 204 | 224 | 213 | 236 |
| B81 | 202 | 227 | 206 | 227 |
| B82 | 170 | 212 | 188 | 216 |
| B83 | 199 | 206 | 204 | 209 |
| B84 | 204 | 208 | 204 | 210 |
| B85 | 194 | | 208 | |
| B86 | 200 | | 204 | |
| B87 | 211 | | 216 | |
| B88 | 193 | 214 | 206 | 220 |
| B89 | 203 | 216 | 212 | 220 |
| B90 | 204 | 211 | 209 | 223 |
| B91 | 179 | 223 | 197 | 232 |
| B92 | 200 | 217 | 209 | 230 |
| B93 | 204 | 213 | 209 | 227 |
| B94 | 204 | 220 | 220 | 229 |
| B95 | 204 | 222 | 204 | 226 |
| B96 | 203 | 216 | 207 | 225 |
| B97 | 215 | | 235 | |
| B98 | 206 | | 209 | |
| B99 | 193 | 220 | 206 | 219 |
| B100 | 210 | 224 | 215 | 225 |
| B101 | 206 | 223 | 216 | 226 |
| B102 | 205 | 227 | 202 | 236 |
| B103 | 205 | 227 | 209 | 231 |
| B104 | 203 | 207 | 210 | 212 |
| B105 | 206 | 204 | 206 | 204 |
| B106 | 204 | 203 | 204 | 208 |
| B107 | 155 | 156 | 186 | 179 |
| B108 | 159 | 160 | 177 | 184 |
| B109 | 166 | 169 | 170 | 187 |
| B110 | 163 | 165 | 182 | 177 |
| B111 | 169 | 169 | 187 | 187 |
| B112 | 162 | 165 | 180 | 183 |
| B113 | 173 | 166 | 196 | 184 |
| B114 | 167 | 164 | 186 | 182 |
| B115 | 175 | 182 | 192 | 206 |
| B116 | | | | |
| B117 | | 179 | | 190 |
| B118 | 174 | | 192 | |
| B119 | 174 | | 198 | |
| B120 | 172 | | 190 | |
| B121 | 163 | | 186 | |
| B122 | 169 | | 181 | |
| B123 | 184 | | 197 | |
| B124 | 182 | | 206 | |
| B125 | 177 | | 194 | |
| B126 | 184 | | 196 | |
| B127 | 163 | 154 | 197 | 176 |
| B128 | 195 | 173 | 219 | 189 |
| B129 | 166 | 160 | 192 | 187 |
| B130 | 170 | 160 | 205 | 186 |
| B131 | 164 | 156 | 193 | 172 |
| B132 | 160 | 150 | 184 | 172 |
| B133 | 171 | 163 | 189 | 180 |
| B134 | 160 | 152 | 185 | 170 |
| B135 | 164 | 156 | 182 | 173 |
| B136 | 164 | 153 | 188 | 166 |
| B137 | 166 | 161 | 184 | 179 |
| B138 | 165 | 156 | 189 | 177 |
| B139 | 162 | 154 | 191 | 196 |
| B140 | 162 | 158 | 187 | 188 |
| B141 | 161 | 171 | 191 | 195 |
| B142 | 164 | 177 | 187 | 195 |
| B143 | 159 | 175 | 189 | 191 |
| B144 | 163 | 154 | 193 | 183 |
| B145 | 163 | 159 | 186 | 182 |
| B146 | 175 | 164 | 192 | 188 |
| B147 | 170 | 165 | 187 | 182 |
| B148 | 165 | 165 | 188 | 183 |
| B149 | 168 | | 190 | |
| B150 | 168 | | 187 | |
| VB1 | 151 | 197 | 167 | 208 |
| VB2 | 211 | 204 | 212 | 205 |

TABLE 4
Results of the catalytical testing of the CO and HC oxidation with
different catalysts after thermal aging for 16 hours at 1000° C.:

| | |
|---|---|
| T₅₀ (CO) [° C.] | T₅₀ (HC) [° C.] |

| | |
|---|---|
| Samples | after thermal aging |

| | | |
|---|---|---|
| B2 | 199 | 205 |
| B3 | 201 | 206 |
| B4 | 197 | 203 |
| B5 | 190 | 196 |
| VB1 | 280 (252*) | 286 (263*) |

*with the twofold amount of platinum

TABLE 5
Results of the catalytical testing of the CO and HC oxidation with
different catalysts after hydrothermal aging for 16 hours at 750° C.:

| | |
|---|---|
| T₅₀ (CO) [° C.] | T₅₀ (HC) [° C.] |

| | |
|---|---|
| Samples | after hydrothermal aging |

| | | |
|---|---|---|
| B8 | 183 | 192 |
| B17 | 179 | 196 |
| B18 | 186 | 195 |

TABLE 6
Results of the catalytical testing of the CO and HC oxidation with
different catalysts after aging with SO₂:

| | |
|---|---|
| T₅₀ (CO) [° C.] | T₅₀ (HC) [° C.] |

| | |
|---|---|
| Samples | after aging with SO₂ |

| | | |
|---|---|---|
| B1 | 223 | 239 |
| B2 | 201 | 211 |
| B3 | 189 | 202 |
| B4 | 181 | 191 |
| B8 | 182 | 188 |
| B117 | 179 | 190 |
| B139 | 185 | 196 |
| VB1 | 182 | 208 |

TABLE 7
Results of the catalytical testing of the CO and HC oxidation with
a series of catalysts, which were tested after thermal aging (700° C.,
16 hours) and subsequent aging with SO₂:

| Example | T₅₀ (CO) [° C.] | T₅₀ (HC) [° C.] |
|---|---|---|
| B1 | 267 | 271 |
| B8 | 224 | 236 |
| B14 | 267 | 279 |
| B18 | 232 | 236 |
| B19 | 228 | 236 |
| B20 | 222 | 234 |
| B21 | 244 | 256 |
| B22 | 245 | 256 |
| B23 | 241 | 241 |
| B24 | 211 | 240 |
| B25 | 201 | 217 |
| B26 | 223 | 235 |
| B27 | 236 | 244 |
| B28 | 224 | 232 |
| B29 | 230 | 242 |
| B30 | 197 | 210 |
| B31 | 194 | 207 |
| B32 | 204 | 208 |
| B33 | 195 | 213 |
| B34 | 194 | 202 |
| B35 | 207 | 225 |
| B36 | 201 | 223 |
| B37 | 192 | 205 |
| B38 | 193 | 202 |
| B39 | 195 | 207 |
| B40 | 199 | 221 |
| B41 | 202 | 215 |
| B42 | 204 | 212 |
| B43 | 216 | 233 |
| B44 | 213 | 226 |
| B45 | 214 | 223 |
| B46 | 202 | 214 |
| B47 | 196 | 196 |
| B53 | 247 | 253 |
| B54 | 207 | 220 |
| B55 | 197 | 209 |
| B58 | 235 | 241 |
| B59 | 240 | 240 |
| B60 | 238 | 244 |
| B61 | 245 | 245 |
| B107 | 240 | 252 |
| B108 | 232 | 232 |
| B109 | 246 | 246 |
| B110 | 227 | 232 |
| B111 | 223 | 235 |
| B112 | 229 | 229 |
| B113 | 227 | 230 |
| B114 | 226 | 232 |
| B115 | 235 | 241 |
| B116 | 184 | 201 |
| B117 | 222 | 235 |
| B118 | 228 | 234 |
| B119 | 212 | 224 |
| B120 | 212 | 217 |
| B121 | 200 | 214 |
| B122 | 202 | 216 |
| B123 | 215 | 223 |
| B124 | 218 | 226 |
| B125 | 220 | 220 |
| B126 | 208 | 208 |
| B127 | 211 | 226 |
| B128 | 221 | 221 |
| B129 | 209 | 226 |
| B130 | 218 | 228 |
| B131 | 202 | 207 |
| B132 | 198 | 209 |
| B133 | 198 | 220 |
| B134 | 185 | 196 |
| B135 | 189 | 196 |
| B136 | 185 | 196 |
| B137 | 197 | 207 |
| B138 | 195 | 205 |
| B139 | 185 | 196 |
| B140 | 191 | 207 |
| B141 | 201 | 207 |
| B142 | 196 | 201 |
| B144 | 191 | 201 |
| B148 | 196 | 201 |
| VB1 | 202 | 220 |

TABLE 8
Results of the catalytical testing of the CO and HC oxidation with
different catalysts after thermal aging for 16 hours at 850° C.:

| Samples | T₅₀ (CO) [° C.] | T₅₀ (HC) [° C.] |
|---|---|---|
| B139 | 186 | 204 |
| B140 | 157 | 186 |
| B141 | 182 | 208 |
| B142 | 182 | 201 |
| B144 | 175 | 204 |
| B145 | 186 | 208 |
| B149 | 179 | 201 |
| B150 | 175 | 190 |
| B151 | 175 | 190 |
| B152 | 172 | 188 |
| VB1 | 203* | 219* |

*after thermal aging for 10 hours at 800° C.

For example, the catalysts B3, B4 and B5 show in the fresh as well as in the aged state (Table 3) and after aging at high temperature (Table 4) very good values for the CO and HC conversion compared to reference VB1.

Exemplarily, the oxidation characteristics of carbon monoxide with catalyst B5 is presented in FIG. 1.

The T₅₀ value of the catalyst B5 was advantageously below the values as initially disclosed for the catalysts of the prior art (EP 0 432 534 B2 and EP 0 566 878 A1).

The catalysts from Example 31, 37, 38, 134, 136, 139 and B144 exhibited a very high activity after thermal aging and subsequent aging with sulfur compared to reference VB1 (Table 7).

X-ray analysis of the phase composition of the catalysts B31 and B24 (each fresh and aged) compared to VB2 and the unloaded carrier oxide exhibited that the tin oxide of the catalyst according to the invention exhibited a nanoparticular or roentgenographically amorphous structure. So, for catalyst VB2, the reflexes of tin oxide at 2θ˜26.7 and 34.0 were clearly visible, whereas the reflexes of the catalyst B31 and B24 were extremely faintly distinct and were very strongly broadened (FIG. 2).

FIG. 3 presents the diffraction analysis of the following samples: (a) VB2, (b) unloaded carrier oxide Siralox 5/320, (c) B24 (fresh) and (d) B24 (aged).

X-ray analysis of the phase composition at catalysts according to B31 and B37 after thermal aging as well as after the catalytical testing revealed no significant change of the samples compared to the fresh sample. Exemplarily supported was said result by the diffraction analysis which are presented in FIGS. 4 and 5. As X-ray diffraction device, an apparatus of Company Bruker (BRUKER AXS with the surface detector GADDS) was applied.

FIG. 4 presents the diffraction analysis of the catalyst from B31 after different pre-treatment steps: (a) fresh sample, (b) aged sample and (c) the fresh sample after the catalytical testing. Siralox 5/170 was used as carrier oxide.

FIG. 5 shows the diffraction analysis of catalyst of Example B37 after different pre-treatment steps: (a) fresh sample, (b) aged sample and (c) the fresh sample after the catalytical testing. Puralox SCFa 140 was applied as carrier oxide.

Concerning the evaluation of the full width at half maximum and evaluation of the particle sizes according to the Scherrer equation, the reflexes at 2θ˜26.7 (d=3.34591) and 2θ˜34.0 (d=2.64021) which have to be assigned to the tin oxide, were evaluated. Characteristical tin oxide particle sizes of less then 1 nm to 30 nm were identified. For B24 (fresh) no reflexes of the tin oxide could be detected. Thus, said sample was “roentgenographically amorphous” relating to tin oxide.

No diffraction analysis of the catalysts according to the invention revealed distinct reflexes, which clearly have to be assigned to the palladium. Therefore, the palladium was also present in a roentgenographically amorphous or nanoparticular form.

The homogeneity of the dispersion of tin and palladium was verified by means of REM/EDX (scanning electron microscopy coupled with energy-disperse X-ray fluorescence) at selected catalysts. Table 9 contains the results of the EDX-analysis, which were normalized to 100%. So, the concentrations of tin and palladium were detected in the meaning of an “element scanning” at three different places, respectively, of selected catalysts (measurement 1, 2 and 3), which were present in granulate form. Siralox 5/320 was applied as carrier oxide, which contained 5 weight-% SiO₂ and 95 weight-% Al₂O₃. The measurements exhibited that both the tin and the palladium were dispersed very homogeneously on the carrier oxide. In particular for each sample, the detected Al/Sn ratios and Sn/Pd ratios were nearly constant (measurement 1, 2 and 3, respectively).

The measurements were carried out with a REM/EDX (Hitachi S3500N with EDX system Oxford INCA). It has to be noted that for the measurement principle significant deviations of the catalyst composition expressed in percentages (in weight-%) can occur compared to the nominal value. However, the relative concentrations of Al (aluminum) to tin (Sn) and palladium (Pd) as well as those of Sn to Pd are more significant than the absolute values.

TABLE 9
Results of element distributions by means of REM/EDX with selected catalysts:

| | | | Element analysis with EDX/Gew. % | | | | | | Al/Sn- | Sn/Pd- |
|---|---|---|---|---|---|---|---|---|---|---|
| Example | Carrier | Measurin | O | Al | Si | Pd | Sn | Pt | ratio | ratio |
| B17 (fresh) | Siralox 5/320 | 1 | 52.00 | 32.20 | 4.42 | 1.23 | 10.09 | n.d. | 3.2 | 8.2 |
| | | 2 | 51.20 | 30.90 | 4.34 | 1.11 | 12.44 | n.d. | 2.5 | 11.2 |
| | | 3 | 84.90 | 31.20 | 4.70 | 0.93 | 8.27 | n.d. | 3.8 | 8.9 |
| B17 (aged) | Siralox 5/320 | 1 | 55.40 | 30.78 | 4.52 | 0.88 | 8.01 | 0.42 | 3.8 | 9.1 |
| | | 2 | 49.68 | 32.91 | 4.18 | 0.84 | 11.99 | 0.40 | 2.7 | 14.3 |
| | | 3 | 51.84 | 31.85 | 4.64 | 1.13 | 10.08 | 0.46 | 3.2 | 8.9 |
| B20 (fresh) | Siralox 5/320 | 1 | 54.38 | 30.04 | 2.49 | 0.98 | 12.12 | 0.00 | 2.5 | 12.4 |
| | | 2 | 53.81 | 30.20 | 2.48 | 0.97 | 12.54 | 0.00 | 2.4 | 12.9 |
| | | 3 | 58.73 | 27.42 | 2.44 | 1.01 | 10.40 | 0.00 | 2.6 | 10.3 |
| B20 (aged) | Siralox 5/320 | 1 | 51.31 | 29.82 | 2.62 | 1.26 | 14.99 | 0.00 | 2.0 | 11.9 |
| | | 2 | 49.98 | 28.31 | 2.71 | 1.27 | 17.74 | 0.00 | 1.6 | 14.0 |
| | | 3 | 57.17 | 29.17 | 2.47 | 0.89 | 10.30 | 0.00 | 2.8 | 11.6 |
| B27 (fresh) | Siralox 5/320 | 1 | 53.93 | 27.79 | 2.12 | 0.51 | 13.83 | 1.81 | 2.0 | 27.1 |
| | | 2 | 49.22 | 30.39 | 2.44 | 0.61 | 16.03 | 1.31 | 1.9 | 26.3 |
| | | 3 | 52.57 | 29.58 | 2.64 | 0.54 | 13.70 | 0.96 | 2.2 | 25.4 |
| B27 (aged) | Siralox 5/320 | 1 | 48.68 | 30.09 | 2.26 | 0.66 | 16.86 | 1.45 | 1.8 | 25.5 |
| | | 2 | 50.59 | 29.57 | 2.28 | 0.61 | 15.68 | 1.27 | 1.9 | 25.7 |
| | | 3 | 51.69 | 29.78 | 2.63 | 0.64 | 14.33 | 0.94 | 2.1 | 22.4 |

The homogeneity of the catalysts as well as the amorphous or nanoparticular structure of the tin on the carrier oxide is also reflected in the specific surfaces of the samples, which were detected by means of BET measurements. So, it was evidenced that the BET surfaces of the catalysts were nearly independent from the tin loading. Also at high tin loading no blockage of the pores of the carrier oxide occurred, which could be caused by crystallizing tin oxide, i.e. “bulk structure”—forming tin oxide. The BET measurements were carried out with a nitrogene sorbtion apparatus of the Company Micromeritics, type TriStar.

TABLE 10
BET surfaces of selected catalysts

| | Example | | | | | |
|---|---|---|---|---|---|---|
| | B8 | B8 | B17 | B17 | B30 | B30 |
| | (fresh) | (aged) | (fresh) | (aged) | (fresh) | (aged) |
| Content of Sn | 5 | | 10 | | 20 | |
| (weight-%) | | | | | | |
| Carrier Oxide | Siralox 5/320 | | Siralox 5/320 | | Siralox 5/170 | |
| Measured BET | 191 | 169 | 210 | 170 | 183 | 149 |
| surface [m²/g] | | | | | | |
| Corrected BET | 203.1 | 179.7 | 236.7 | 191.6 | 229.5 | 186.8 |
| surface [m²/g] | | | | | | |

The measured BET surface is that surface, which directly resulted from the measurement at defined initial weight of a sample. The adjusted BET surface is the measured surface, which was then normalized to an uniform amount of carrier oxide.

FIG. 6 presents the cumulated HC emissions of the catalyst according to Example B153, which were obtained on the engine test station in the new European vehicle cycle. An engine of the company VW, 1.9 L TDI, was the test carrier. As reference catalyst, the corresponding serial catalyst was employed, which contains as active component platinum.

FIG. 7 shows the cumulated CO emissions of the catalyst according to Example B153, which were obtained on the engine test station in the new European vehicle cycle. Also, the engine of the company VW, 1.9 L TDI, was the test carrier. As reference catalyst, the corresponding serial catalyst, which contains as active component platinum, was employed.

The FIGS. 6 and 7 show that the new oxidation catalyst not only clearly falls below the European Norm EU-IV for CO, but also outperforms the reference catalyst on basis of platinum both in the CO and in the HC oxidation. The repetition of the test demonstrates that the catalyst according to the invention has a stable conversion and is not deactivated during the test.

Examples of the Embodiment of the Catalysts, where the Tin Oxide and the Palladium are Present on the Nanoparticular Carrier Oxide:

In the figures show:

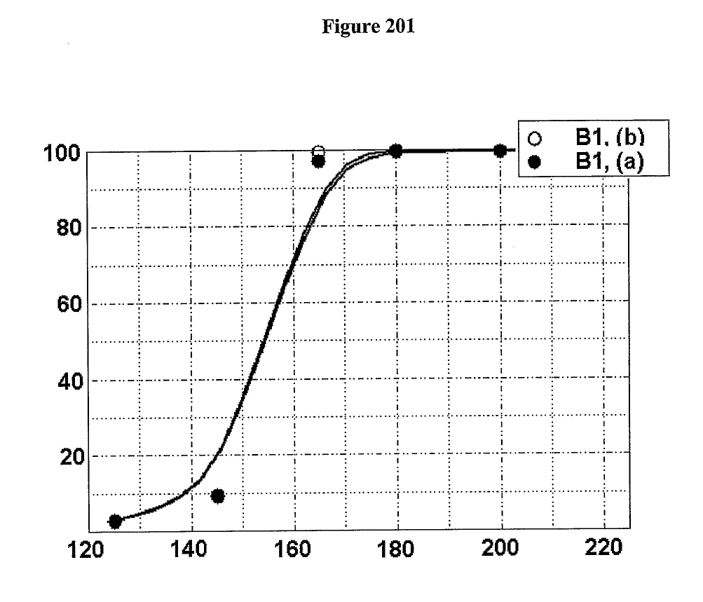

FIG. 201 the CO conversion as function of the reaction temperature with the catalyst sample according to Example 201 (B201) with a noble metal loading of 31 g/ft³ in (a) fresh state and in (b) after thermal aging for 16 hours at 700° C. In FIG. 201, in the horizontal axis the temperature is plotted in the unit ° C. and in the vertical axis the CO conversion in the unit %.

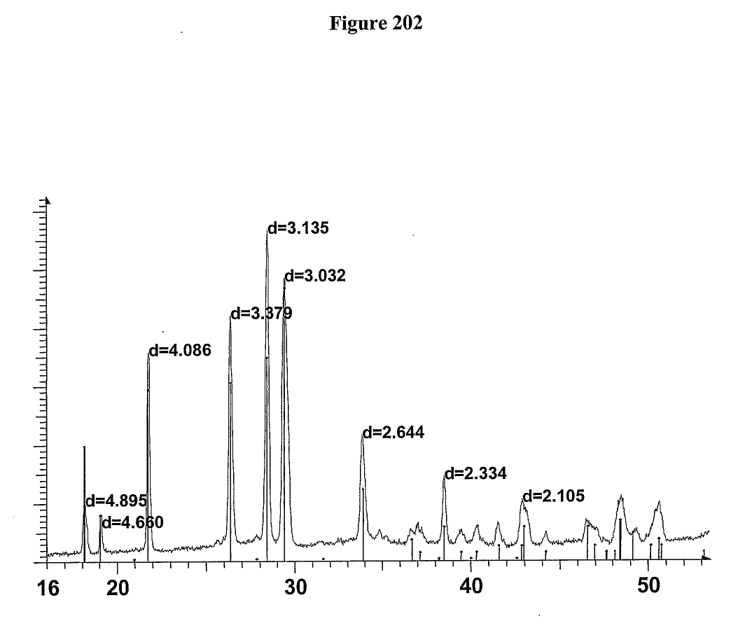

FIG. 202 the X-ray diffraction analysis of the catalyst of Example B203 in “fresh state”. In the figure, in the horizontal axis the 2-theta scale is plotted in the unit degree and in the vertical axis the x-ray intensity in arbitrarily selected unit.

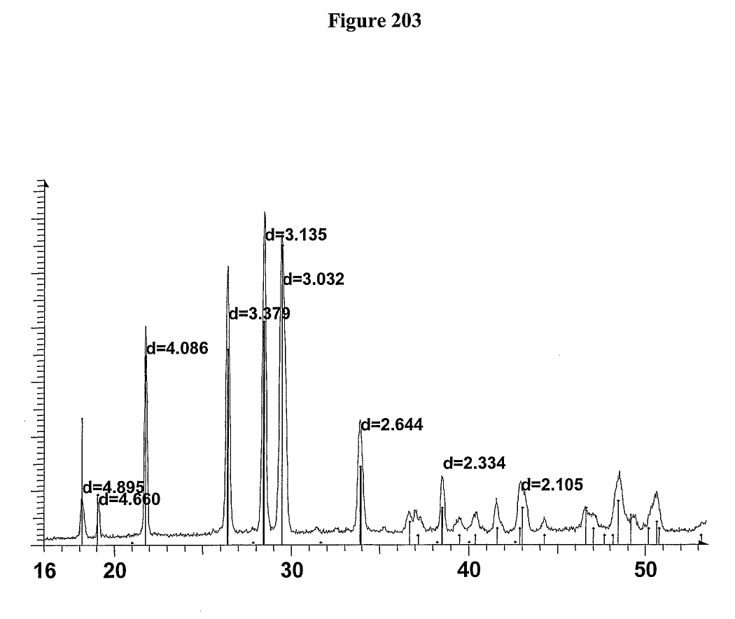

FIG. 203 the X-ray diffraction analysis of the catalyst of Example B206 in “aged state” (i.e. after hydrothermal aging at 700° C.). In the Figure, in the horizontal axis the 2-theta scale is plotted in the unit degree and the X-ray intensity in the vertical axis in arbitrarily selected unit.

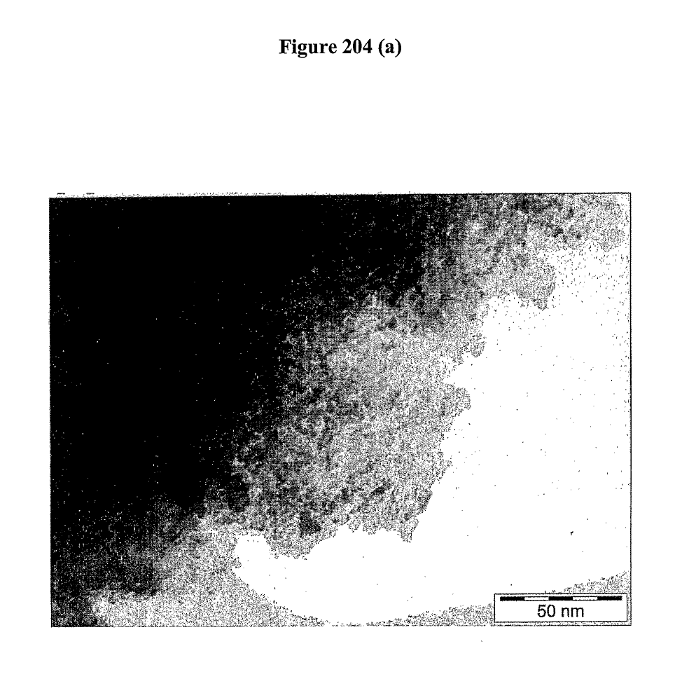

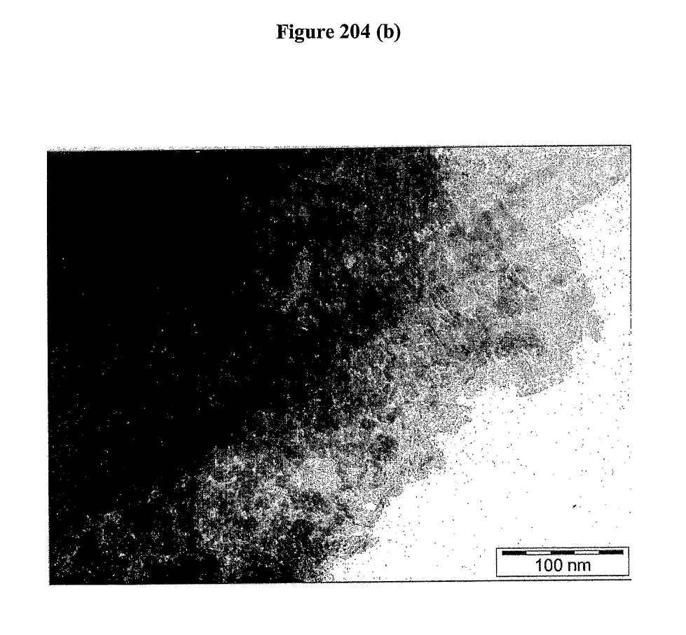

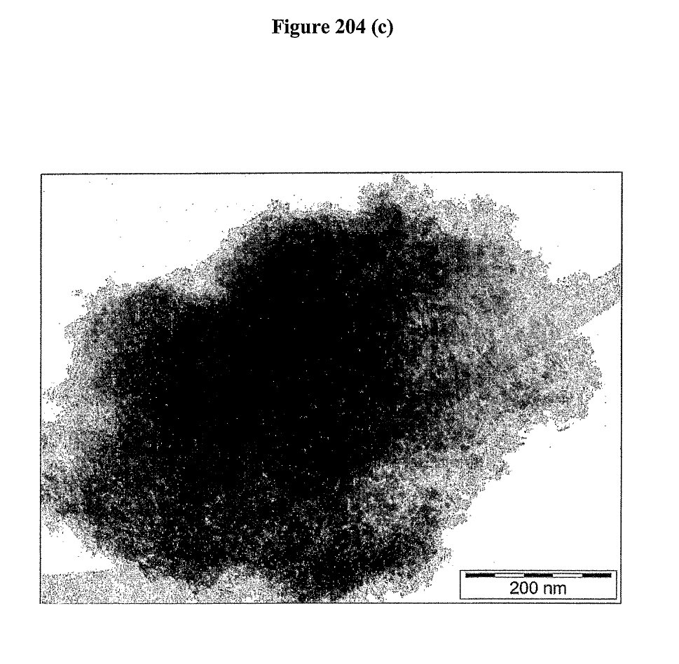

FIG. 204 the TEM takings which were taken from Example B203: (a) presentation of a range of the sample with high resolution (the scale bar shows a length range of 50 nm), (b) presentation of a range of the sample with average resolution (scale bar shows a length range of 100 nm) and (c) presentation of a range of the sample with low resolution (scale bar shows a length range of 200 nm).

Catalytical Testing

Activity measurements were carried out in a full automated catalyst facility with 48 fixed bed reactors made from stainless steel (the inner diameter of an individual reaction chamber was 7 mm), which were run parallelly. The catalysts were tested under conditions similar to Diesel exhaust gases in a continuous operational mode with oxygen surplus under following conditions:

| | |
|---|---|
| Temperature range: | 120-400° C. |
| Exhaust gas composition: | 1500 vppm CO, 100 vppm C₁ (octane), |
| | 300 vppm NO, 10% O₂, 10% CO₂, 6% |
| | H₂O; balance - N₂. |
| Gas flow rate: | 45 1/h per catalyst |
| Catalyst mass: | 0.5 g |

The catalysts, which are listed in the examples, were manufactured as honey-comb-shaped catalysts. Then, they were mortared and were used as bulk material for the measurements.

As reference catalyst (VB) a commercial honeycomb-shaped oxidation catalyst for exhaust gases from Diesel engines with 3.1 g/l (90 g/ft³) platinum was used. 0.5 g of said catalyst were mortared and also used as bulk material for the measurements. The comparison measurements between the catalysts according to the invention and the reference catalyst were carried out on basis of the same catalyst mass. Thereby, for the catalysts according to the invention a clearly lower noble metal mass was used in the reactor.

The evaluation of CO and CO₂ was carried out with ND-IR analysis of Company ABB (type “Advance Optima”). The determination of the hydrocarbon was carried out with FID of Company ABB (type “Advance Optima”). O₂ was determined with a λ-sensor of the Company Etas, whereas the measurement of NO, NO₂ and NOₓ was carried out with a UV apparatus of Company ABB (type “Advance Optima”).

For the evaluation of the catalysts, the T₅₀ values (temperature where 50% conversion is achieved) of the CO oxidation was used as criteria for the oxidation activity.

The T₅₀ values of the catalysts in the fresh state as well as after the different aging thereof (thermal aging and hydrothermal aging) are summarized in Table 202.

Thermal and Hydrothermal Aging

The thermal aging of the catalysts was carried out in a muffle furnace at a temperature of 700° C. in air. Thereby, the catalysts were kept for 16 hours at said temperature and were then cooled down to room temperature.

The hydrothermal aging was carried out under the same conditions as the thermal aging. However, 10 volume-% water in air were fed into the muffle furnace.

### EXAMPLES

### Example 201

For the manufacture of a catalyst according to the invention, the nanoparticular carrier oxide (Disperal P2) of the Company Sasol was dispersed in water by stirring at room temperature. The formed coated suspension had 20 weight-% solid. Said coating suspension exhibited very good adhesion properties and was applied without addition of other binders for the manufacture of the washcoat. As catalyst carrier, a honeycomb-shaped core made from cordierit with 400 cpsi (channels per square inch) of the Company NGK was used, which was cut before to a format of 2*2*2 cm. The core was coated with washcoat by dunking into the coating suspension. The coating was dried at 80° C. in air and was calcinated for 2 hours at 500° C. in air in the muffle furnace. The washcoat loading was 109 g/l. The washcoat loading represents the solid portion of the washcoat which is applied onto the shaped body after calcination.

The application of the active component onto the washcoat was carried out by impregnation of the washcoat-containing core with 3562 μl of an aqueous nitric acid-containing tin oxalate/palladium nitrate solution. Thereby, 1998 μl of an aqueous 1.0 molar solution, which consisted of tin oxalate and 30% nitric acid (HNO₃), with 164 μl of an aqueous HNO₃-containing 0.75 molar palladium nitrate solution [Pd(NO₃)₂-solution] were mixed and diluted with 1400 μl water. Subsequently, the core was dried at 80° C. and was calcinated in air for 2 hours at 500° C. (termed as “fresh”).

A portion thereof was calcinated in air for 16 hours at 700° C. (termed as “thermally aged”).

The completed catalyst contained 31 g/ft³ palladium.

### Example 202

The catalyst was manufactured analogously to Example 201, whereby a mixture of 80 weight-% of the nanoparticular carrier oxide (Disperal P2 of Company Sasol) and 20 weight-% beta-zeolite (H-BEA 25 of Company Süd-Chemie) were applied. The total solid amount in aqueous suspension also was 20 weight-%.

The completed catalyst contained 50 g/l washcoat and 28 g/ft³ palladium.

### Example 203

The catalyst was manufactured analogously to Example 201, whereby for the coating suspension the nanoparticular carrier oxide (Disperal) of Company Sasol was applied.

The completed catalyst contained 69 g/l washcoat and 39 g/ft³ palladium.

### Example 204

The catalyst was manufactured analogously to Example 201, whereby a mixture of 95 weight-% of the nanoparticular carrier oxide (Disperal P2) of Company Sasol and 5 weight-% SiO₂ were used in form of a colloidal suspension (Ludox CL) of Company DuPont.

The completed catalyst contained 27 g/l washcoat and 23 g/ft³ palladium.

### Example 205

The catalyst was manufactured analogously to Example 201, whereby a mixture of 60 weight-% of the nanoparticular carrier oxide (Disperal) of Company Sasol and 40 weight-% beta-zeolite (Zeocat FM-8/25H of the Company Zeochem) were used.

The completed catalyst contained 100 g/l washcoat and 28 g/ft³ Pd.

### Example 206

The catalyst was manufactured analogously to Example 201, whereby gallium was used as dopant.

The completed catalyst contained 50 g/l washcoat and 14 g/ft³ palladium.

### Example 207

The catalyst was manufactured analogously to Example 201, whereby indium was used as dopant.

The completed catalyst contained 50 g/l washcoat and 14 g/ft³ palladium.

In Table 201, the specifications of the catalysts according to the invention are summarized as Examples 201 to 207. Compositions of the active component are reported based on weight-%, whereby said specifications relate to the elementary form of the noble metals, of the tin and of the dopant component.

The X-ray diffraction analysis of Example B203 in the fresh state and of Example B206 in the aged state, which are presented in the FIGS. 202 and 203 reveal no crystalline phases of tin oxide-containing or palladium oxide-containing components. The reflexes, which have been found in the diffraction analysis have to be assigned to the structure of the carrier oxide, which consists of cordierite. The diffraction analysis which is shown in the Figures was taken with a BRUKER AXS-apparatus, which was equipped with a GADDS surface detector.

The TEM-takings, which are presented in FIGS. 204 a-c exhibit the catalyst from Example B203 in the “fresh state”. By means of the TEM-takings, one can realize that the samples exhibit no characteristics of inhomogeneity. By means of EDX-takings, no ranges were detected, which had agglomerations of palladium- or tin-containing components. Within the resolution limits of the used apparatus, therefore, the homogeneous distribution could be confirmed. The takings were taken with a TEM-apparatus H-7500 of the Company Hitachi combined with an EDX-measuring device INCA of the Company Oxford Instruments.

TABLE 201
Composition of the catalysts:

| | | Loading | | Loading | Active component | | | |
|---|---|---|---|---|---|---|---|---|
| | | with | | with | [weight-% | | | |
| | | noble | | wash- | based on | | | |
| Exam- | Noble | metal | | coat | washcoat mass] | | | |
| ple | metal | [g/ft³] | Washcoat | [g/l] | Pd | Sn | Ga | In |
| B201 | Pd | 31 | Disperal P2 | 109 | 1 | 30 | | |
| B202 | Pd | 28 | 80% Disperal | 50 | 2 | 40 | | |
| | | | P2 20% Beta- | | | | | |
| | | | Zeolith | | | | | |
| B203 | Pd | 39 | Disperal | 69 | 2 | 40 | | |
| B204 | Pd | 23 | 95% Disperal | 27 | 3 | 50 | | |
| | | | P2 5% SiO₂ | | | | | |
| | | | (as colloidal | | | | | |
| | | | Ludox CL | | | | | |
| | | | Suspension) | | | | | |
| B205 | Pd | 28 | 60% Disperal | 100 | 1 | 20 | | |
| | | | 40% Beta- | | | | | |
| | | | Zeolith | | | | | |
| B206 | Pd | 14 | Disperal P2 | 50 | 1 | 20 | 0.5 | |
| B207 | Pd | 14 | Disperal P2 | 50 | 1 | 20 | | 0.5 |
| VB201 | Pt | 90 | | | | | | |

TABLE 202
Results of the catalytical testing of the CO oxidation with catalysts,
which were tested after thermal or hydrothermal aging:

| | | Mass of noble | |
|---|---|---|---|
| | | metal in measured | |
| | Noble metal | catalyst | T₅₀ (CO) [° C.] |
| Example | (NM) | [g] | aged at 700° C., 16 h |
| B201 | Pd | 0.00078 | 157 |
| B202 | Pd | 0.00081 | 158 |
| B203 | Pd | 0.00107 | 168 |
| B204 | Pd | 0.00072 | 171 |
| B205 | Pd | 0.00080 | 154* |
| B206 | Pd | 0.00044 | 168* |
| B207 | Pd | 0.00044 | 168* |
| VB201 | Pt | 0.00250 | 172 |

*hydrothermal

1. A method of using a catalyst containing tin oxide, palladium and a carrier oxide for the simultaneous removal of carbon monoxide and hydrocarbons from oxygen-rich exhaust gases of lean combustion engines, characterized in that tin oxide and palladium are present on the carrier oxide in a particle size of from 0.5 to 100 nm and said carbon monoxide and said hydrocarbons are catalytically oxidized by said catalyst to water and carbon dioxide.

2. The method as claimed in claim 1, characterized in that the carrier oxide contains silicon or aluminum or silicon and aluminum.

3. The method as claimed in claim 1, characterized in that the catalyst contains a zeolite.

4. The method as claimed in claim 3, characterized in that said zeolite is applied in form of H-ZSM-5, dealuminated Y-zeolite, hydrothermally treated Y-zeolite, mordenite or zeolite-β.

5. The method as claimed in claim 1, characterized in that said catalyst is doped with one or more elements selected from the group platinum, rhodium, iridium or ruthenium.

6. The method as claimed in claim 1, characterized in that said catalyst is doped with one or more promoters selected from the group indium oxide, gallium oxide, alkali metal oxide, earth alkali metal oxide and rare earth element oxide.

7. The method as claimed in claim 1, characterized in that said catalyst contains boron oxide.

8. The method as claimed in claim 1, characterized in that the amount of tin oxide, calculated as tin, based on the mass proportion relatively to carrier oxide is from 3 to 50 weight-%.

9. The method as claimed in claim 5, characterized in that the amount of palladium and platinum, rhodium, iridium and ruthenium based on the mass proportions relatively to the carrier oxide is from 0.2 to 10 weight-%.

10. The method as claimed in claim 5, characterized in that the mass proportion of tin oxide, calculated as tin, to the sum of the weights of palladium and platinum, rhodium, iridium and ruthenium is in the range of from 2.0:1 to 25:1.

11. The method as claimed in claim 5, characterized in that the mass proportion of palladium to platinum in the catalyst is in a range of from 0.3:1 to 1000:1.

12. The method as claimed in claim 5, characterized in that the mass proportion of palladium to rhodium, ruthenium, iridium or a mixture thereof is in a range of from 2.1:1 to 1000:1.

13. The method as claimed in claim 5, characterized in that the weight proportion of palladium to the sum of the weights of platinum and at least one further metal in the catalyst from the platinum group is from 0.3:1 to 1000:1.

14. The method as claimed in claim 3, characterized in that the total amount of zeolite based on the carrier oxide preferably is from 5-50 weight-%.

15. The method as claimed in claim 6, characterized in that the weight proportion of tin oxide, calculated as tin, to the sum of the weights of all promoters, calculated as elements, is in a range of from 0.66:1 to 33:1.

16. The method as claimed in claim 7, characterized in that the weight proportion of the carrier oxide to the boron oxide, calculated as boron, is in a range of from 1:0.00005 to 1:0.2.

17. The method as claimed in claim 1, characterized in that said catalyst is employed as powder, granulate, extrudate, shaped body or as coated honeycomb body.

18. The method as claimed in claim 1, characterized in that said use comprises the simultaneous removal of carbon black particles by oxidation.

19. The method as claimed in claim 18, characterized in that said catalyst is employed as surface coating for carbon black particle filters.

20. A catalyst containing tin oxide, palladium and a carrier oxide, characterized in that said tin oxide and said palladium are present on the carrier oxide in a particle size of from 0.5 to 100 nm, said catalyst contains a zeolite, and said catalyst is doped with one or more elements selected from the group platinum, rhodium, iridium or ruthenium, or said catalyst is doped with one or more promoters selected from the group indium oxide, gallium oxide, alkali metal oxide, earth alkali metal oxide and rare earth element oxide, or said catalyst is doped with one or more elements selected from the group platinum, rhodium, iridium or ruthenium and one or more promoters selected from the group indium oxide, gallium oxide, alkali metal oxide, earth alkali metal oxide and rare earth element oxide.

21. A method comprising:
catalyzing, with a catalyst, reaction of hydrocarbons and carbon monoxide to yield water and carbon dioxide;
the catalyst including a mixture of tin oxide, palladium and a carrier oxide, in which the tin oxide and the palladium have a particle size of 0.5-100 nm.

22. The method of claim 21 wherein, during the using step, the carbon monoxide and the hydrocarbons are in an exhaust gas of a combustion engine.

23. The method of claim 21 wherein the carrier oxide includes an oxide of silicon.

24. The method of claim 21 wherein the carrier oxide includes an oxide of aluminum.

25. The method of claim 21 wherein the catalyst includes a zeolite with a weight of 5-50% the weight of the carrier oxide.

26. The method of claim 21 wherein the catalyst includes boron oxide, with the weight of boron in the boron oxide being at least 0.00005 times the weight of the carrier oxide.

27. The method of claim 21 wherein the weight of tin in the tin oxide is 3-50% the weight of the carrier oxide.

28. The method of claim 21 wherein the total weight of palladium, platinum, rhodium, iridium and ruthenium in the catalyst is 0.04-0.5 times the weight of tin in the tin oxide.

29. The method of claim 21 wherein the total weight of palladium, platinum, rhodium, iridium and ruthenium in the catalyst is 0.2-10% the weight of the carrier oxide.

30. The method of claim 21 wherein the catalyst includes platinum, with a weight at least 1/1000 the weight of the palladium.

31. The method of claim 21 wherein the catalyst includes metals from the platinum group, with a total weight at least 1/1000 the weight of the palladium

32. The method of claim 21 wherein the catalyst is an extrudate.

33. The method of claim 21 wherein the catalyst is a coated honeycomb body.

34. The method of claim 21 wherein the catalyst is coated on carbon black particle filters.

35. The method of claim 21 wherein, during the using step, the catalyst catalyzes the oxidation of carbon black particles.
